(19) United States
(12) Patent Application Publication
(10) Pub. No.: US 2009/0006201 A1
(43) Pub. Date: Jan. 1, 2009

(54) Method and apparatus for storing and accessing URL links

(76) Inventor: Walter L. Faseler, JR., Austin, TX (US)

Correspondence Address: RICK B. YEAGER, ATTORNEY, 10805 MELLOW LANE, AUSTIN, TX, 78759, US

(21) Appl. No.: 12/062,719

(22) Filed: Apr. 4, 2008

Related U.S. Application Data
(63) Continuation-in-part of application No. 10/650,872, filed on Aug. 28, 2003, now abandoned.

(51) Int. Cl. G06Q 30/00; G06F 3/048

(52) U.S. Cl. 705/14; 715/777; 715/853

(57) ABSTRACT

Information access is organized in a tree structure of items where each item has an XML data structure with a plurality of containers. The containers identify local or remote information which is accessed and displayed in a single display with multiple pains. The containers may include additional content, related advertising material, or other information such as search terms. A user may preview the name, URL, and descriptive material before accessing the URL link. Sponsor advertising or other graphics may be displayed in proximity to the tree structure display. URL links are to local files, applications, and remote files such as web pages and fttp file locations.

### FIELD OF INVENTION

The current invention relates to a computer-based functional advertising device and tool for organizing, searching, displaying, and sharing a computer desktop or handheld device presentation of links to Internet addresses, files and computer programs in a manner that permits sponsor advertising and the display of file contents, notes or other descriptive content in description panes.

### BACKGROUND OF THE PRESENT INVENTION

There is a need for an efficient means of categorizing, recalling, and accessing web links, programs and local files and databases, together with descriptive information to support specific tasks. At one level, a local computer file is addressed by the same general Uniform Resource Locator (“URL”) mechanism as an Internet file. For example, all are accessed by citing a specific, computer recognizable address. Computer users have access to large amounts of information including local files, local applications, and internet sites. There is also a practical need for gathering and display of notes or other helpful information with certain of the items used or visited by the computer user. The management of this information requires effective methods of storing and recalling both local files and internet files, and methods for quickly launching application programs or the organized collection of related resources. One use of such a representation is a single desktop system for consolidating Internet searches or running one or more local programs, together with associated files. A benefit of such a single desktop or handheld system is that a number of applications may be efficiently launched from the same site.

In prior art systems, a user might store local files in one or more local directories; use a bookmark in a favorites file to save a useful Internet site; and launch local programs from desktop icons, from a start programs menu, or from clicking on an executable file from a directory. Once a URL is listed as a favorite, the web site or web page can be accessed at a later time through an Internet browser such as AOL, Microsoft Internet Explorer or Netscape Navigator. The user typically accesses the favorites or bookmarks list, scrolls to identify the desired web site, and double clicks on the URL or file alias. By contrast, in the current invention, the Internet link is stored locally and can be accessed without first launching a web browser. This ability to access Internet links and local files or applications has usefulness in desktop, portable notebook, and handheld device applications.

### SUMMARY OF THE INVENTION

The current invention provides a novel way of presenting information in a manner that provides faster and convenient access to application programs, local files, and Internet files. The invention presents these programs and files in a common intuitive outline format that permits both standard and customized presentation. The files and associated information are maintained as lists that can easily be updated, manipulated, copied, shared, transported, mailed, or downloaded.

This format provides an efficient means of content management for a group or association, which can provide a valuable service to its members by offering the outlines to its members. The members can then either use the outlines as presented, or further customize the information.

One business application of the current invention is for an organization to provide useful outline to its members or customers, and for the organization to therefore maintain visibility on user desktops through the display of the organization's icon. One or more specific information folders may also be provided to permit fast and efficient access to the organization's services or advertisers.

The invention provides faster access to application programs such as email, and typically opens directly to specific functional parts of the programs rather than to introductory screens. The QLynx application runs on top of other programs to permit a high level functional navigation through multiple applications.

In one embodiment, QLynx allows the user to enter item names, an optional URL, and an optional description. The URLs may be several lines of text characters to specify the actual address of the item, either local or internet. The item name may be a convenient abbreviation or alias of the actual URL address, or may be standalone information that is not associated with a URL address. In one embodiment, the descriptive pane can include full text of web site, or several pages of text. The text in the descriptive pane is searchable so that the user may enter a desired text string. In one embodiment, the system will return create and return a new list of links related to the search term. In some examples, the descriptive pane may be used for separate pages of a document, so that key pages may be searched and recalled individually.

Various embodiments of the invention include the maintenance and display of item names only, item names and a URL, item names and a description, and item names with a URL and a description. In some cases, such as a list of contacts or a first stage outline of a project, the item name alone carries sufficient information for the user, and a URL or description block are not required.

In other cases, it is desirable to have a name and a description. In these cases, the description is visible as the name is reviewed, and the combined information in the name and in the description is sufficient for the user. Examples of this type of information display include lists of content where all of the content may be displayed in the descriptive block such as checklists, reference materials, and pending legislation where the name is used for subject matter organization, and the description is used for actual portions of the legislation. This case is also appropriate in project management tools where the basic outline of a name section is expanded through materials added in the descriptive blocks associated with the names.

In other cases, such as some internet links, it is desirable to have a name and a URL, in these cases, the name or the organizational context of the name provides sufficient information for the user to decide to access the URL link.

In many other cases, it is useful to have all three types of information—the URL, the name, and descriptive material. In these examples, the user typically either needs to use an application program or to obtain more detailed information through the URL link. The name and the structure of how the name is presented relative to the QLynx session and project provides a context for the link, and the descriptive block provides some information relative to the link as well as a way to search information related to the link or to preview the link.

### Efficient Display

In one embodiment, up to 16 tabs are presented on a computing display device such as a handheld computing device or a monitor for a desktop computer. Each tab is selectable, and opens a scrollable page where URL links are typically presented in a nested outline form. Each tab represents a .qpf file, and is a project. The outline may be expanded or contracted at any level. The outline represents a partial tree view of information and links. The combination of multiple tabs and outline representation permits the efficient organization and presentation of large amounts of information, or content, such as described in the examples below. The information accessibility is further enhanced by the definition at each access point of a descriptive name for the link; the actual link to an Internet page or local file; and an optional scrollable information block which can be used to present descriptive material, a summary, or some portion of the actual content of the link. The combination of the descriptive title and the descriptive material allows the user to effectively preview the content of the actual link. In some cases, the user may obtain sufficient information from the preview without opening the link.

### Preview

The organization of information facilitates the efficient review of a large number of potential links by a user. For instance, rather than clicking on a URL link in favorites, the user may “preview” the site by reviewing the descriptive block. That review opportunity allows the user to be more selective in which links are accessed. The access is also typically faster than through the favorites list on an Internet browser because the links content summary can be reviewed, and the link can be accessed, without launching a browser. Similarly, the content or a summary of the content of local files such as word processing files, spreadsheet files, pdf files, databases, imaged documents, sound and video files, emails and faxes can be reviewed without launching a particular application program. Thus the current invention permits large amounts of information to be organized, and the invention permits that information to be efficiently previewed and accessed.

### Eliminating Local and Internet Navigation

A traditional use of the computer is to launch a program which performs a function and saves a files. For example, a word processor is launched, a screen permits creation of the document and a document file is saved.

A traditional use of the Internet is to launch a browser, navigate to a page, select a portion of a page, a red the page. The page may be saved, or transmitted, but does not typically result in anything. Other functions may be launched, or other actions performed.

The current invention brings the Internet and desktop to the user where it can be utilized, commented upon, and saved to the extent that the uses can be perpetuated in a note, and the page can be revisited without navigation or browsing.

Program functions—spreadsheets, data bases, word processors and all of their files, can be directly launched and used by going directly to the products of the programs, and by organizing into dossier or project folders.

As an example, the QLynx Project Assistant is task-oriented to quickly deliver relevant links and files, and to directly launch programs. Its organization is a tree format which permits a logical presentation of all relevant matters of a particular project within a file format which permitted display many thousands of link connections to the files and webpages.

A programmed data query delivers up-to-date results as soon as a query is selected, and not after it is requested by search term.

This efficient delivery of information may be provided by a sponsor, and the information may be complemented with logo reinforcement, advertising, or messaging.

### Data Structure

The data structure is typically provided in XML, so that it is compatible with most operating systems and computer applications. A plurality of containers may be populated manually, semi-automatically, or automatically from one or more local or remote sources. The data structure is consistent for all sources and file types including local data files, local applications, web-based applications, web pages.

One aspect of the current invention is a robust data structure. By way of example, an RSS feed includes a plurality of items or entries, where each item includes the following metadata or “containers”.
Title
link
Description

The current invention typically includes much more metadata. In one example of the current invention, a data structure is provided with ten containers:

### EXAMPLE

### 10 Containers

In one example, a data structure is provided with 10 containers as described below. In other examples, fewer or additional containers can be provided.
Name. This container is for an item name.
URL. This container is for a URL address. The URL is the primary navigation descriptor for launching of services—programs, files, and the Internet. By comparison, a “favorite” or “bookmark” is typically two containers—a name and a URL link. The RSS structure added a description.
Description, This container is for a description field of the database which permits 2 mb or 32000 k information in a searchable RTF format. An RTF format permits hyperlinks.
CURL1. This container is designated as a Console URL which permits a secondary URL to display complementary information to the particular task, as in a “contact” page accompanying the primary web site destination. This display may be provided in a separate console or window or may be accessed such as by a tab.
CURL2. This container is designated as a second Console URL. In one example, the container is used as a placeholder for a Q-Tag. A Q-tag is primarily used for tagging, such as marking and highlighting various terms for identification. The field is also available for the programming of functions or other uses.
GURL1. This container provides access to a first graphic—Graphic URL1. In some embodiments, the graphic fields are use to hold other URL or text information. Graphic fields are generally useful to enhance search by providing preview information, or by providing direct content or advertising. In some embodiments, these graphic fields provide graphics that are specifically related to an item so that a corresponding graphic display changes according to which item is selected.
GURL2. This container provides access to a second graphic—Graphic URL2
GURL3. This container provides access to a third graphic—Graphic URL3. In one embodiment, the GURLs permit display of advertising and other graphic content. VURL. This container provides access to a VideoURL which may be used for programming media and graphics items from the tree. In one embodiment, the form of the video file must be compatible with the onboard Windows Media Player. The content is typically any audio or video file for entertainment (‘jukebox’ functions) or information and advertising.
ID. This container holds an identification field which is used for internal creation of identifiers for distinct items in the tree. In one example, this field contain generated random numbers which identifies the various nodes in the tree structure, and is changed each time a file is saved.

These containers support a rich data structure. In one example, there are multiple “graphics” containers. These graphics containers may include searchable text in any language, image files, and video files. The data structure is typically pointers so that the information accessed is the latest information about an item.

The containers may originate from multiple local or remote sources. This feature provides a “coordinating database” aspect where the representation of the metadata on a single screen provides the ability to consolidate relevant and timely information from multiple sources. In some cases, the consolidation of this information is the only required functionality.

The metadata may be displayed without launching a local or remote URL. This provides a substantial efficiency in reviewing large amounts of information, such as Internet search results. In cases where more processing is required than simply viewing the information, the fact that the relevant information is presented in a single location provides enhanced processing efficiency.

The presentation of the metadata can be selected for greater efficiency. For example, various presentation layouts of the container information may be provided.

The metadata can support business objectives in addition to information sharing. For example, one use of some of the containers is to provide advertising for the sponsor of the information. This advertising can be specifically related to factors such as the time, the user, or the information displayed. Metrics can be provided to prove the effective exposure of this advertising.

### Tree Representation

The list of items is typically presented in a highly structured format. For example, in one embodiment, the items are presented in a plurality of labeled tabs, where each tab represents a tree. The items are branches on the tree. The user may use this structure to better understand the relationship of the items. The tree can have multiple levels so that information can be displayed to the appropriate degree of detail. An item in a tree can be moved or copied to another location, at any level, in that tree or in any other tree without disruption to the data representation. The particular tree or trees containing an item provides inherent information about the item to a user. The particular location of an item within the tree provides additional information about the item. As an item is selected, the metadata for the item is displayed. In many applications of the current invention, that display of the metadata is sufficient. In other applications additional processing of that information may be provided.

### Content Management and Sponsorship

These features provide an efficient “content management” function ability that is particularly useful to organizations such as associations, alumni groups, governmental agencies, publications, and web hosts. In one business model for the current invention, an organization sponsors the use of the tool for its members. The organization benefits by providing valuable content and management of that content for its members; and by the frequent display of its advertising logo.

Since members may use the current invention as a desktop management device and perform most computer tasks from the tool—such as accessing local files and programs, directly sending email without opening a mail tool, and accessing Internet links without first going through a browser, it is expected that in many cases the tool will become the preferred operating format for the user.

### Large Amounts of Information

Another benefit of the current invention is the ability to organize and selectively display large amounts of information. The invention permits the concurrent access to multiple QLynx Project Files, where each Project File presents multiple tabs, and each tab presents an outline page of expandable files. Each file may present further level of file structures so that the user can quickly navigate to a particular desired link. The navigation capability is further enhanced by the combination of descriptive titles and the presentation of descriptive preview materials for a link. This structure permits a large number of links to be effectively organized in a useful and customizable manner.

### Coordinating Database

One aspect of the current invention is a “coordinating database.” The term refers to the ability of the program to gather data from a wide variety sources and display the results to permit coordination or distillation of the information from various sources. The limitation of information—from Internet sites, files, dbases and depository is limited only by the capability of the information to display in any browser.

### Advertising

In one embodiment, the current invention serves as a desktop billboard where a sponsor's advertising logo may be visible on a user's computer display. Since the content and content management of the current invention may be very useful to a user, the advertising logo may be visible on the display device for long periods of time. In other embodiments, one or more advertising graphics or messages associated with an item may be displayed when an item is selected.

### Multiple Trees

One aspect of the current invention is the use of multiple trees to represent information and links to information. The invention supports multiple sessions where each session can have multiple projects. Each of these projects may be represented by a tree structure.

In various embodiments, the current invention provides a novel advertising medium, a novel display and organization of information, a project assistant for incrementally developing information related to a project, a structured search tool with preview capability, and a data resource and data management tool.

### DESCRIPTION OF FIGURES

FIG. 1 is a flow chart for prior art file access through a browser or application.

FIG. 2 is a flow chart for QLynx file access

FIG. 3 is a schematic showing the tab and tree structures of an embodiment

FIG. 4 is a sample initial screen for QLynx

FIG. 5A is a high level flow chart for a single session

FIG. 5B is a detailed flow chart for tab operations in the example of FIG. 5A

FIG. 6 represents multiple sessions

FIG. 7 represents operations for an active session

FIG. 8 shows a refresh sequence

FIG. 9 shows a recent file operation

FIG. 10 is a data structure diagram

FIG. 11 is an example of an add an item dialogue box

FIG. 12 is an example of accessing information by name field only

FIG. 13 is an example of accessing information by name field and URL

FIG. 14 is an example of accessing information by name field and description

FIG. 15 is an example of adding a URL link to the example of FIG. 14

FIG. 16 is an example of media links

FIG. 17 is an example illustrating multiple tabs

FIG. 18 is an example for advertising content

FIG. 19 is an example for copying and pasting folders and lists

FIG. 20 is an example of creating a filtered list

FIG. 21 is a desktop management example

FIG. 22 Example of Windows™ Manager

FIG. 23 is a monthly publication example showing content and advertising links

FIG. 24 is an example of an application directed at teenagers

FIG. 25A is an example of launching a video application

FIG. 25B is an example of searching and launching an audio application

FIG. 26 is an example of a website monitoring device for an intelligence agency

FIG. 27 is an example for a retired persons organization

FIG. 28 is an example for a local bar association

FIG. 29 is an example for a teachers organization

FIG. 30 is an example of license agreement content

FIG. 31 is an example of a listing of colleges and applications

FIG. 32 is an example of a patent search

FIG. 33 is a real estate example

FIG. 34 is an example of a projected use for a governmental agency.

FIG. 35 is an example of teachers notes and email generation

FIG. 36A is a Spanish language example for an oil company

FIG. 36B is a Spanish language example for an airline

FIG. 37 Example of Guide Content for Austin, Tex.

FIG. 38A is a prior art representation of a favorites XML data structure with a name and URL.

FIG. 38B is a prior art representation of an RSS XML data structure with a name, URL, and description.

FIG. 38C is a representation of an XML data structure embodiment of the current invention with 10 containers.

FIG. 38D is a representation of a tree data structure embodiment of the current invention.

FIG. 39 is a representation of an application tool screen 315 of the current invention and a representative data structure 310.

FIG. 40 is a representation of an application tool screen 315 of the current invention, a representative data structure 310, and local or web URLs 312.

### DETAILED DESCRIPTION OF EMBODIMENT

### Accessing a QLynx File

### Prior Art—Internet File Access

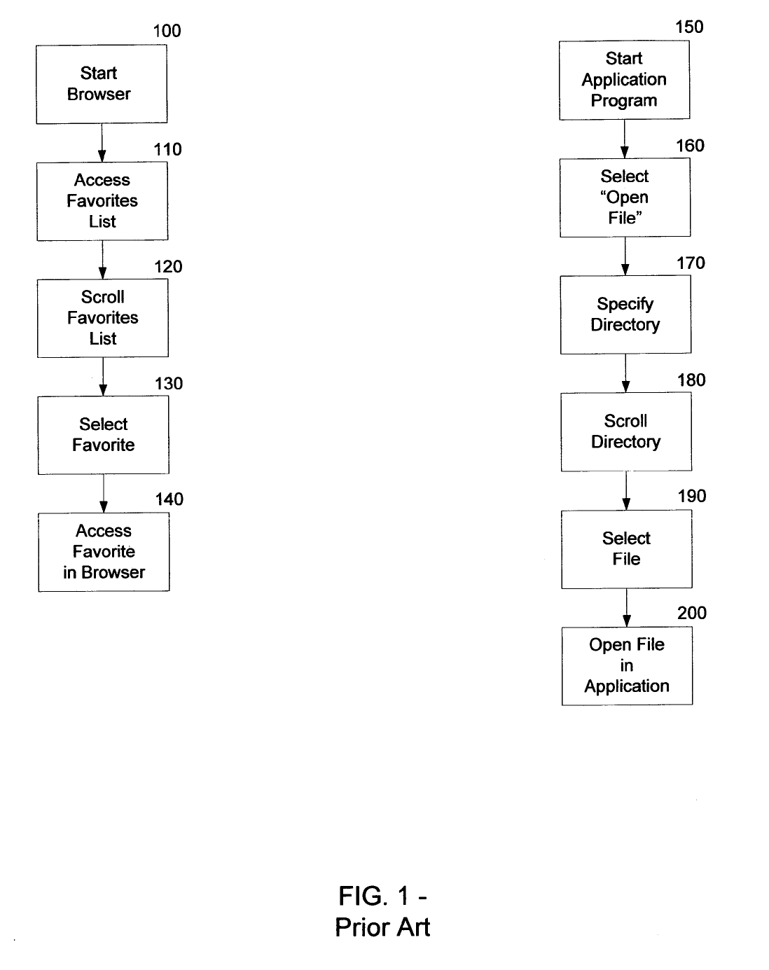

Referring now to FIG. 1, prior art internet file access typically requires starting a browser at step 100, accessing a favorites list at step 110, scrolling the favorites list at 120, selecting an item at step 130, and accessing the item which may be a file, URL or program through the browser at step 140.

In a similar manner, an application program may be started at step 150. The operating system, such as Windows™ typically provides a File/Open function at step 160. The user specifies the directory or folder at step 170, scrolls the directory or folder at step 180, and selects a file at step 190. The file is opened into the application at step 200.

### QLynx File Access

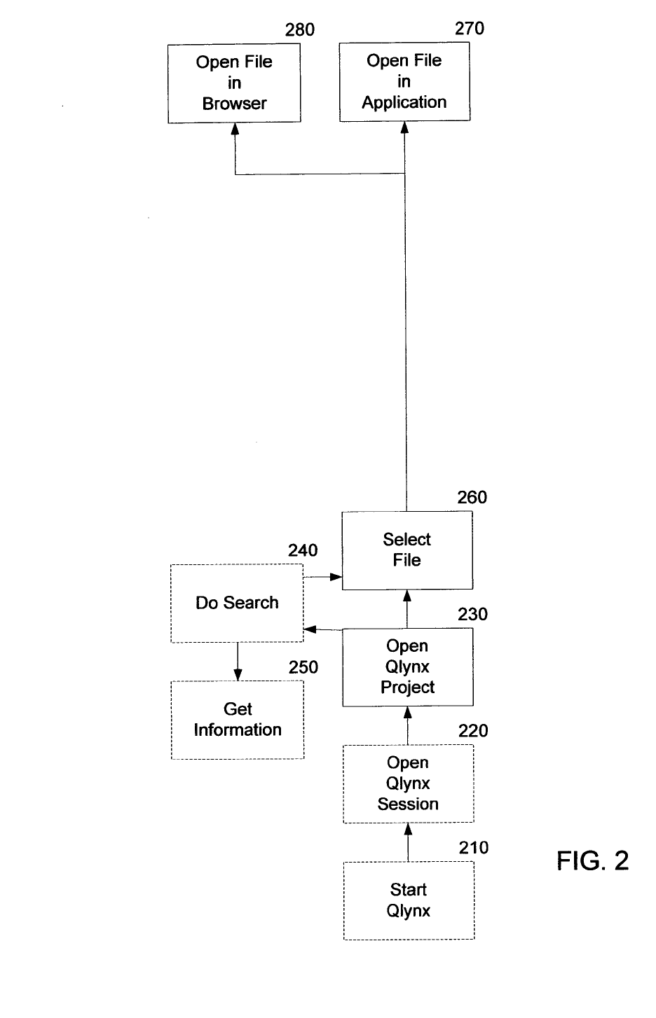

Referring now to FIG. 2, one aspect of the current invention is the ability to open files directly into a browser or other application. At step 210, QLynx is started. In many embodiments, QLynx will be running on top of other applications. In a multi-tasking environment, QLynx typically remains available for other access. At step 220, the user may open a different QLynx session. In many embodiments, the default QLynx session will be used. At step 230, the user selects a desired tab or project. In some examples, the file will be selected at step 260 from the project tab. In other examples, the user may conduct a search at step 240 on descriptive material name or URL to locate a desired file or location such as a web page or ftp file location. This search may be conducted on any desired portion of the outline tree representation. In some examples, the information associated with the name of the file is all that is required, and the user may access this information at step 250 without opening the file or an application. In other examples, the selected file will open into a browser at step 280 or into another application at step 270.

### QLynx File Structure

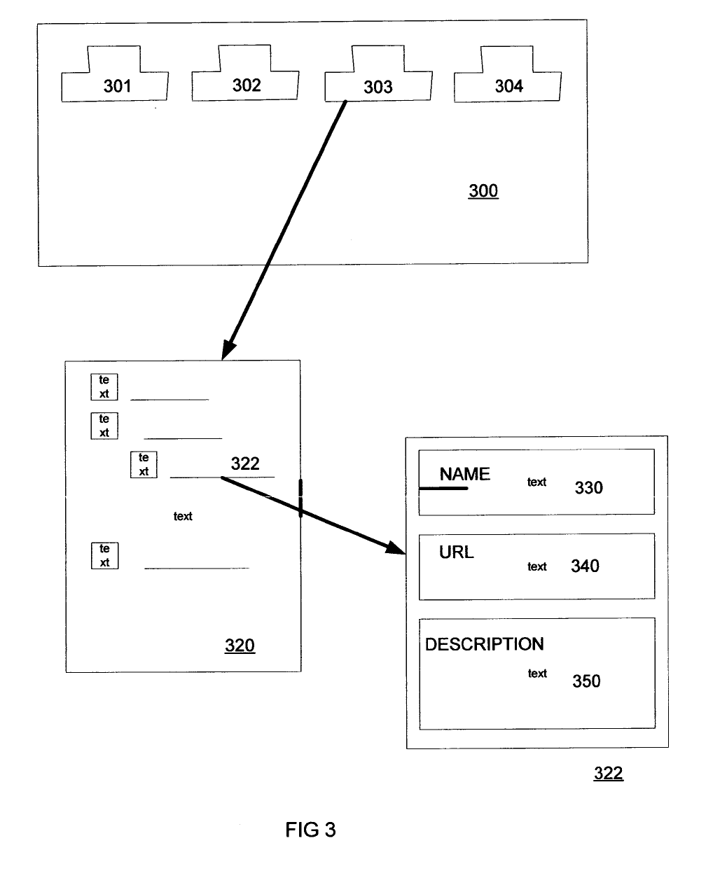

Referring now to FIG. 3, which is a schematic of the file structure of a QLynx embodiment, one embodiment of the invention includes a multiple tab structure 300, as illustrated by tabs 301, 302, 303, and 304. Each tab represents a tree structure, as illustrated by tab 303 and tree structure 320. As illustrated by item 322, each entry within a tree structure includes a name 330, an optional URL 340, and an optional description 350. The position of a name within a tab and within the tree structure associated with the tab provides a useful context for the link. As the user reviews these names, additional information may be obtained from the complete name or from the description.

In this embodiment, the representation format of multiple projects or tabs, tree structures within the tabs, and display of the full name, URL link, and description is common to each QLynx session. Thus the format permits a common structure and display of information so that in some cases, desired information is obtained by reviewing the name, and no URL or descriptive material is presented. In other cases, additional or related information is presented in the descriptive block, and no URL is presented. In other cases, the name and a URL is presented so that the user may access a link identified by the name. In other cases, all three types of information are presented—the name, the URL, and descriptive material, so that the user may search or preview the descriptive material in order to decide whether to access the link. The descriptive material may include one or more graphics image associated with the link so that the images may be used to preview the URL, advertise, or inform the user.

### Creating a QLynx File

### Data Elements

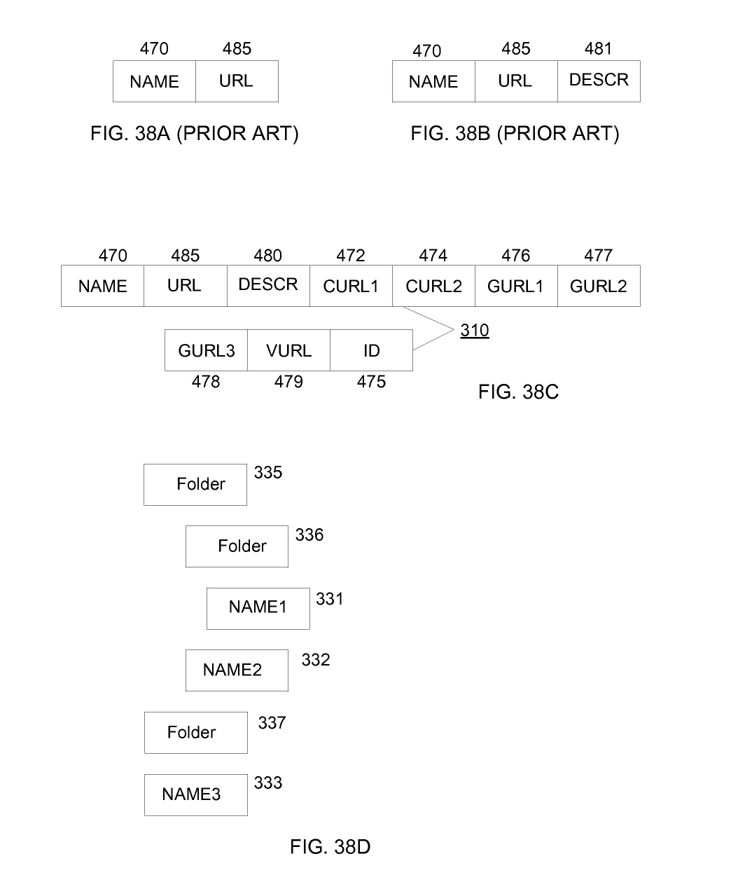

FIG. 38A is a prior art representation of a favorites XML data structure with a name and URL 485. A typical browser bookmark has this structure of only a name 470 and a URL associated with the name. FIG. 38B is a prior art representation of an RSS XML data structure with a name 470, URL 485, and description 481.

FIG. 38C is a representation of an XML data structure 310 of this embodiment of the current invention. with 10 containers. These ten containers are by way of example only, and there is not a limit to the number or variety of containers. In this example, a limit of ten was selected as being a convenient number for programming efficiency and consistency. In this example, a Qlynx file is created using the data structures as defined above with each item having containers for Name 470, URL 485, Description 480, CURL1 472, CURL2 474, GURL1 476, GURL2 477, GURL3 478, VURL 479, and a unique ID 475.

FIG. 38D is a representation of a tree data structure embodiment of the current invention. In this example, the tree structure includes both folders such as 335, 336, 337 and selectable items such as 331, 332, and 333.

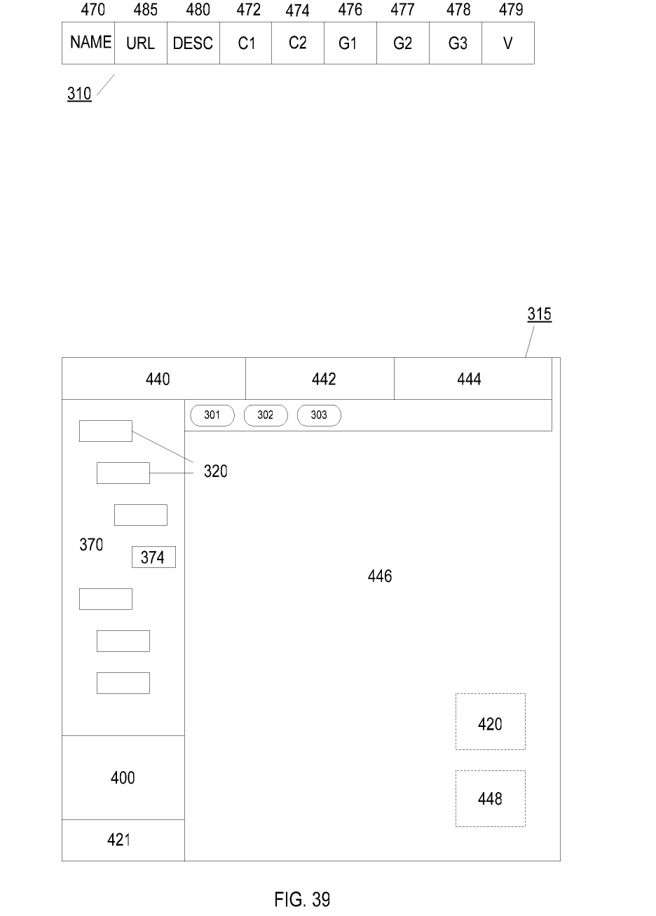

FIG. 39 is a representation of an application tool screen 315 of the current invention and a representative data structure 310. As described below, one aspect of the invention is that the screen may have multiple display areas such as 440, 442, 444, 370, 446, 420, 448, 400, and 421 where each display is generated from a container. The number, size, and orientation of these displays is configurable. Each tab 301, 302, 303, etc. generates a separate tree structure. Some of the entries in the tree may be folder names for organization, and other entries may be items such as 374 which have a data structure 310 that is used to generate the display information.

### Q-Notes

Typical databases contain fields which must be precisely defined and “keyed” to permit certain actions. In some prior art examples database fields are limited to a maximum of 255 characters. Spreadsheet cells permit more, but practicality of display limits the use of larger numbers and can effectively destroy use of the worksheet.

In this example, the description container, also called Q-Notes has a default of 32,000 characters per item or field. That full field may be searched, so that the concept of searches becomes that of extracting useable common text information, and not the preparation of lists, number analysis or the report concept of databases. Q-Notes permit the program to be a robust text analysis tool. The search can be performed in more than 100 languages. A description editing capability is provided. An asterick (“*”) or other special character may be provided as part of the Q-Note and a subsequent search can be performed for all items having an asterick in the Q-Note. This tagging capability enhances the search and information management functions of the tool.

### Q-Tags

In one embodiment, the CURL2 container is used to hold a Q-TAG which permits associating a simple name to an item.

### VURLs and CURLs

By placing the target URL in the CURL container, a preview of the website may be obtained. More precisely, the web site is displayed in a small window which provides a preview capability. When multiple items in a tree are scrolled, this preview may be viewed in order to determine whether to access the URL in a larger display window.

By putting a graphic in the VURL container, a media player plays the still picture. This approach provides information similar to news headlines or catalog items.

### Tree Structure Example

In this embodiment, a tree structure is used to organize a set of items. Prior art typically permits one page generation per selection of a particular bookmark or favorite. Although it is possible to add as many favorites as desired, typical computer use shows a practical limitation of links. Organization of items in a tree structure permits more efficient management and access of the items, as well as the display of information from multiple sources per selection.

In one example, 15 tabbed columns may be displayable in a full screen. In this example, the effect of the tabbed columnar display is to permit the 15 files to be open simultaneously with as many as 80,000 entries per file column. In some tests of the present invention, more than 1.25 million links have been open.

By optimizing the data in each link or item, there are theoretically possible, 1.25 million×10 programmable data entry points in a single display. Memory limitations reduce the practical number of links. Because the columns are replaceable, there are very large possibilities of displaying data.

### Overall Organization

During a QLynx session, a QLynx Project File (“QPF”) is loaded by the user. Typically related to an area of interest for a user or sponsor organization, each QPF database contains various sets of data entry points. Since multiple sessions may appear on a desktop or display, it is often convenient to use different QPFs for different topics, uses and interests. Alternately, most media, including files, applications and URLs for a user can be accessed from a single project file. In this discussion, the QPF is presented as a unique format of a file. In other examples, this invention may be implemented in standard formats such as XML, MYSQL, ORACLE, DB2, or other forms of data. As noted, this ability becomes the coordinating database when all of the information from various sources is considered in the context of the question at hand, and not just in the context intended by the database, the website or file actually analyzed.

### EXAMPLE

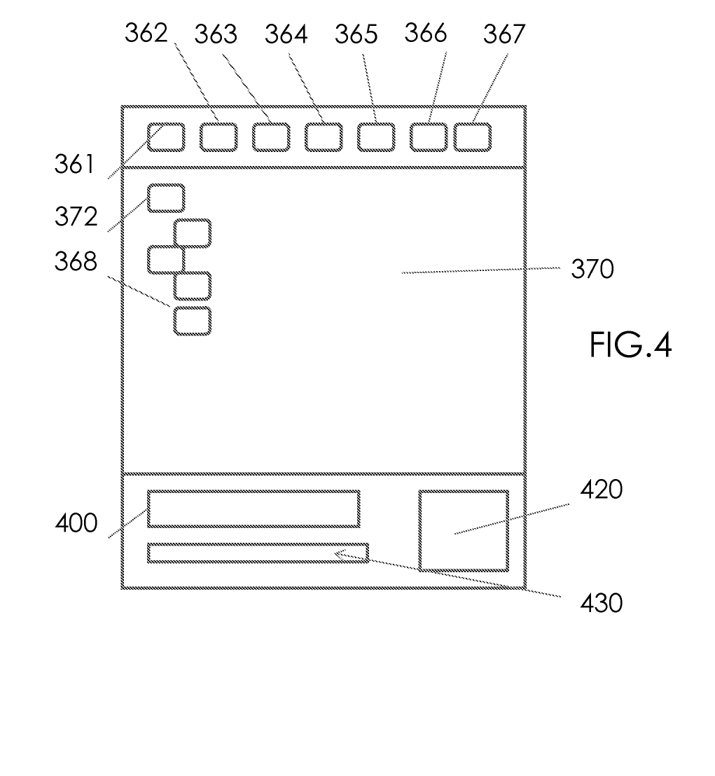

Referring now to FIG. 4, which is a sample screen for QLynx, the screen includes a tool bar 360, a file display 370, a description screen or pane 400, an icon area 420, and a URL address 430. The tool bar includes icons for open a tab 361, open a file 362, add an item 363, delete an item 364, describe properties of an item 365, switch an item 366 and search 367.

In this example, the QPaw 368 is an icon which represents that the item has a URL link. The QPaw may be replaced by other icons such as a sponsor logo.

Each Project File may include multiple tabs, where a tab represents a project which is a tree structure of names. Each name may be associated with a link, a description, a link and a description, or neither a link nor a description. The sample screen shows a single tab 372. Additional tabs may be created by using the add item icon 363. For each tab, the file space by be organized as an outline of files. At each level of the link outline, the subsidiary links can be minimized or expanded.

### Architecture

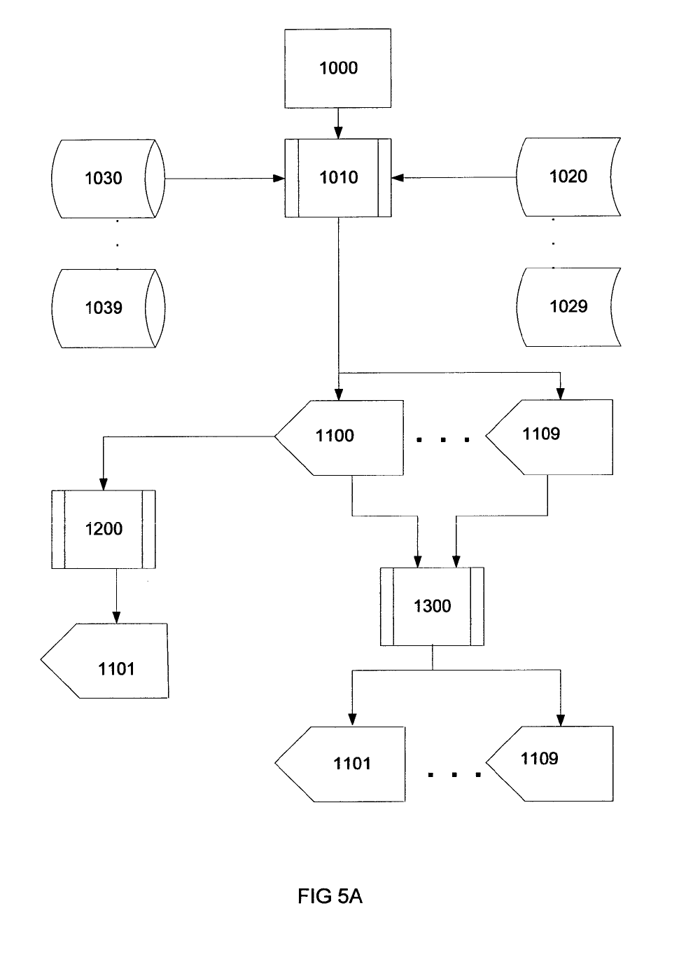

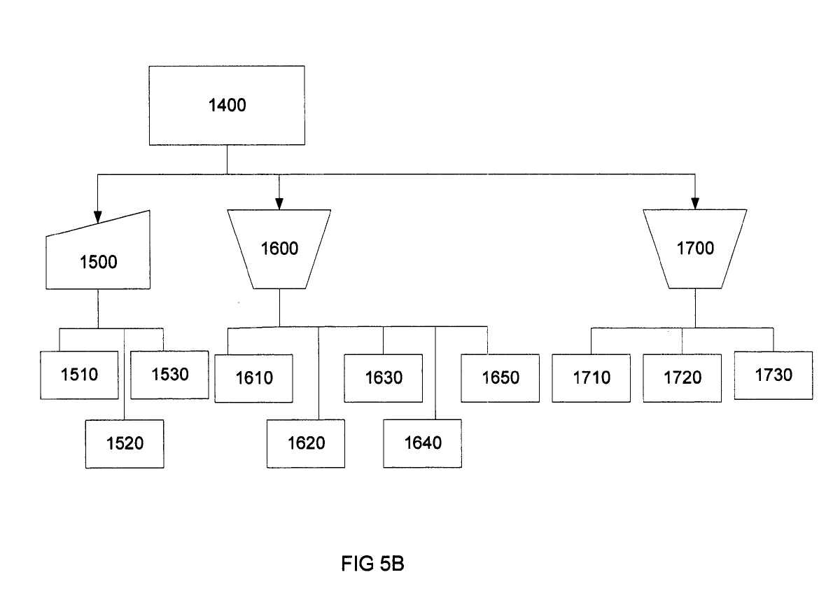

FIG. 5A is a high level flow chart for a single session of an embodiment of the current invention. At step 1000, a first session is initialized, and a tree generation screen 1010 is presented. The tree generation screen accesses either an existing stored file as indicated by stored file 1020 to stored file 1029; or a manual input file as indicated by manual input file 1030 to manual input file 1039. At step 1100, a particular tab is accessed as illustrated by tabs 1101-1109. For each tab, the user may perform an Intertab operation 1200, or an intratab operation 1300.

Referring now to FIG. 5B, in one example, tab operations 1400 include manual inputs 1500, manual item operations 1600, and manual file operations 1700. Manual inputs include add item 1510, delete item 1520, and select item 1530. Manual item operations include cut 1610, paste 1620, drag 1630, drop 1640, and sort 1650. Manual file operations include save 1710, save as 1720, and print 1730.

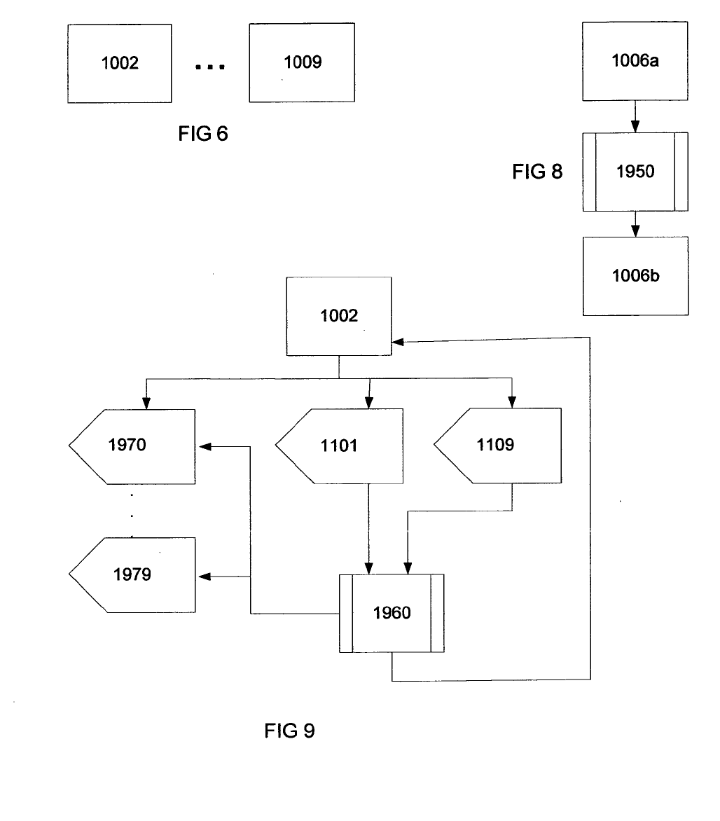

Referring now to FIG. 6, multiple sessions as indicated by session 1002 to session 1009 may be accessed. Each of these sessions is called a QLynx Project File. In one embodiment, 16 sessions may be opened concurrently.

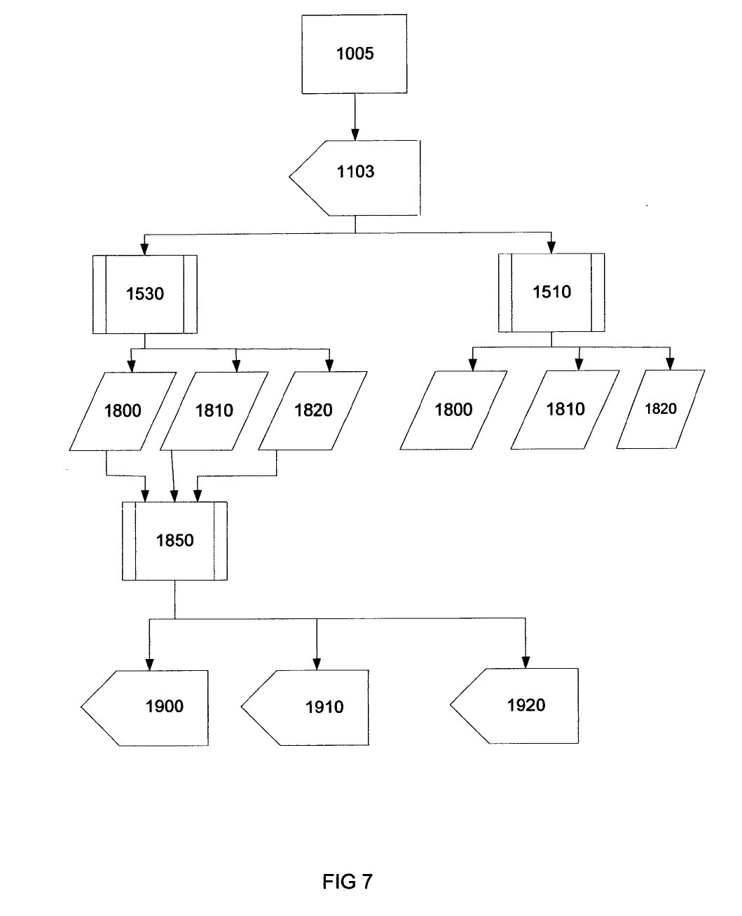

Referring now to FIG. 7, for each active session x 1005, a particular tab, as indicated by tree 1103 may be accessed. For each tab, the user may select an item 1530 or add an item 1510. When an item is selected, its URL 1800, file 1810, or program 1820 are accessed, and the item becomes the active item 1850. In one example, an active item may activate an application or a file such as a URL browser 1900, a file editor 1910, or an application program 1920. When add an item 1510 is selected, the item URL 1800, file 1810, and application 1820, are recorded.

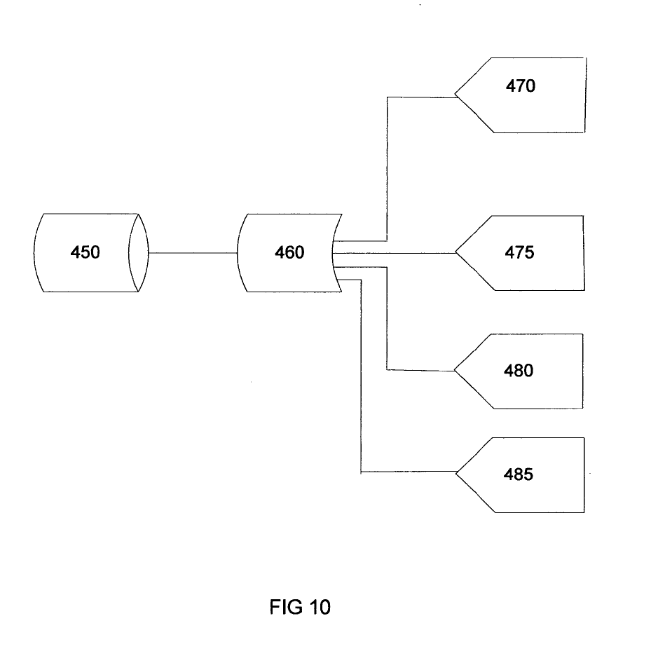

Referring now to FIG. 8, which is a refresh sequence, for a session 1006a, a refresh operation is initiated 1950, and the session 1006b is updated.

Referring now to FIG. 9, which is a recent file operation, a session 1002 may access a file such as file 1970 to file 1979, or a tab tree such as tab 1101 to tab 1109. The tab or file then becomes the recent file 1960, and the session 1002 continues.

Referring now to FIG. 10 which is an example schematic of a data layout and data flow, the database is contained within a .qpf 450 file. The .qpf file has data records 460 that can be items or folders. Data records contain data elements 470, 475, 480, 485. The data elements represent the Name 470, ID 475, Description 480, and URL 485. In this example, if the data element ‘URL’ is blank then the data record is considered a folder rather than an item.

### Building a Project File

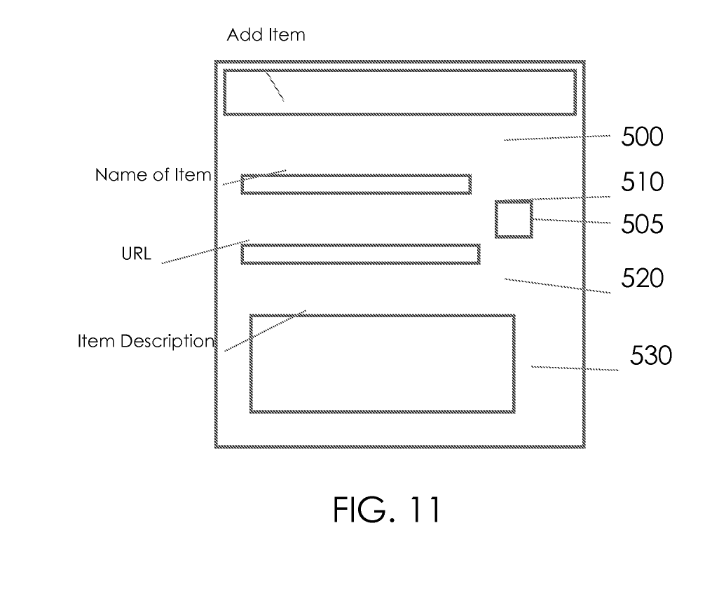

In operation, a desired tree structure is created where the higher levels of the tree may be expanded, and the lower levels typically represent links to captured Internet web pages, local files, local applications, notes, graphics, and descriptions. One way to capture the links is illustrated in FIG. 11 which is an example add item dialog box. As each link is captured, a dialog box 500 permits the user to specify the name of the item 330 in a name field 510 and an item description 350 in an item description field 530. The user may select in a button menu 505 whether the item is a folder or a short cut. If the user selects short cut, then a URL 340 may be entered in a Shortcut URL field 520.

In some embodiments, each item may be assigned a unique key at the time that the item is created. This key may be used to differentiate items, such as during a search. In some embodiments, a Q-TAG may be used as a short descriptive reference or other organizational reference to classify, research or refer to a particular item—even by marking items with a unique tag for quick selection by the search function to create a new QPF in the tab sections.

An internet link may be captured by several methods including typing the link address directly in the field provided, pasting the link address into the field from any other location such as a file or browser address block, or copying a shortcut or means of grasping the information in the Windows “copy” mode. The typical structure of an internet link may be its simple website address (http://www.website.com) or a very complex search structure: (http://www.google.com/url?q=http://www.1shoppingcart.com/app/adtrack.asp%3FAdID %3D34278&sa=1&ai=AnVwGuUf9-E87kUoiUQboxqrAye6QR3_y64NwWrgABUpTAAO1DEwABgpF&num=1)

In Other Embodiments, the Links are Created Automatically.

A local file is captured by properly inserting its full path name into the field provided. A typical entry would be c:\word processor\wordprocessor.exe file or c:\working files\word processor text file.type. These files are opened in their native application if the file type is associated with the program in the Windows environment. Files with an *.exe extension open the program identified.

One advantage of the Qlynx approach is that local files may open faster than with prior art methods because it is not necessary to open the application before accessing the local file.

Local entries may be captured or inserted into QLynx by typing or by selecting the item in the browse window, which opens standard Windows Files dialogs. The Description field is intended for more than a mere simple description; in one embodiment, it has a capacity of 32,000 characters, or about 10 word processing pages, and about 2000 database records. The name field and description field may be multilingual—from universal languages such as English, Spanish and French to Arabic, That, Hebrew, Russian, Greek and any other language characters supported by the Windows Environment. The name and description fields may be searched in a variety of languages.

### Manipulating a Project File or Library

The links in a Project File or Library may be filtered by searching and sorting the name or description. The Project File representation tree structure may be modified by a cut and paste operation on particular links and folders, and links may be moved in that manner from one tabbed project to another. Cut, copy, paste operations may also be applied to a link or to a combination of links in a partial tree structure.

User access to particular links is facilitated by the use of multiple sessions, multiple tabs (project files) within the QLynx Interface, and an outline form within each tab. This organization of links permits the user to represent and effectively manage large numbers of links. The organization and presentation of the links may be manipulated from the user display with typical operations as described above.

### Accessing the Links

The combination of the representation of the links through libraries, tabs or projects, and outline form; the direct access of links to specific web pages, local files, and applications; and the preview features of the links assist the user in efficient access to information. In many examples, the links are supplied by a sponsoring entity such as an affinity group so that each of the links has been evaluated or filtered for relevance to the user. Thus the user is able to effectively select one or more URLs from a highly organized set of filtered links. This effective availability of relevant links is in strong contrast to the unorganized presentation of typical Internet search results. This usefulness, or “content”, to the customer supports advertising revenue in some embodiments.

### Direct Access and Data Transparency

Once a link is selected for access, a specific web page can be directly accessed, in effect, without launching the browser by going directly to the link. Because this function works directly on the link, regardless of its level from the “home page” of the website, this process avoids a typically navigation through cascading menus or link trails. In a Windows environment, local programs are accessed through menus or desktop icons. In the current invention, local programs may be accessed from the same outline form as other files and Internet pages. Thus, a single representation is used for all types of information and application program access. This single representation capability and direct access capability effectively make the data system invisible to the user. It is not necessary for the user to be an expert in computers or in various software applications to access and use Qlynx.

### Access by Name, Link, and Description

QLynx allows the user to enter item names, a URL or null URL such as a period, and optional descriptions. Some examples use only the name, some examples use a name and URL, some examples use the name and the description, and some examples use a name, URL and a description. In this way, an outline is created which can be accessed and expanded as the user's project evolves.

### Example

### Accessing Name Only

In this embodiment, only the name is entered or displayed. The item name may be a convenient abbreviation or alias of the actual URL address, or may be standalone information that is not associated with a URL address.

An example of using only a name is a list of contacts where all required information is presented in the name block. The contacts may be presented alphabetically, by functional group, or by any desired arrangement.

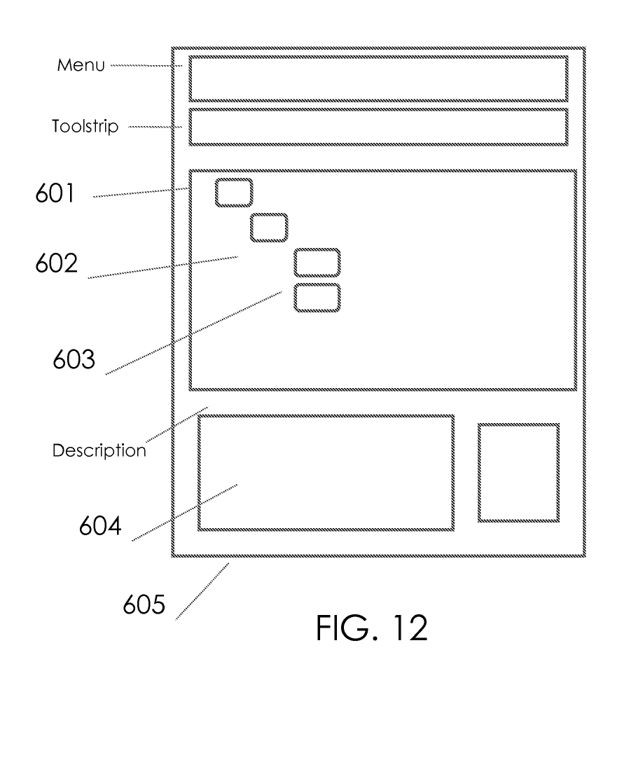

Referring now to FIG. 12, another example of using only a name is a template for the first step of a project assistant. In this example, the parts of a patent application are outlined. The main tab 601 is for the Qlynx patent application. A folder 602 is provided for a list of illustrations. One of the illustrations is “FIG. 12—Example of accessing information from name field only” 603. In this example, the title is sufficiently descriptive to indicate what illustration is required. If additional information were required, then it could be entered in the Description field 604. In this case, the URL address is null as indicated by the “..” in the URL field 605.

In this example, an early step in developing a large project is to provide a high level outline of tasks. Each of the high level tasks is organized in an outline form and presented as a task name. At subsequent steps of the project, as discussed below, additional information and links are recorded. This type of example includes proposal development and project development, such as for developing content for an association. The arrangement of names serves as a template for developing customized content for the association.

### Example

### Accessing Name and URL

The URLs may be a simple identifier or several lines of text characters to specify the actual address of the item, either local or internet.

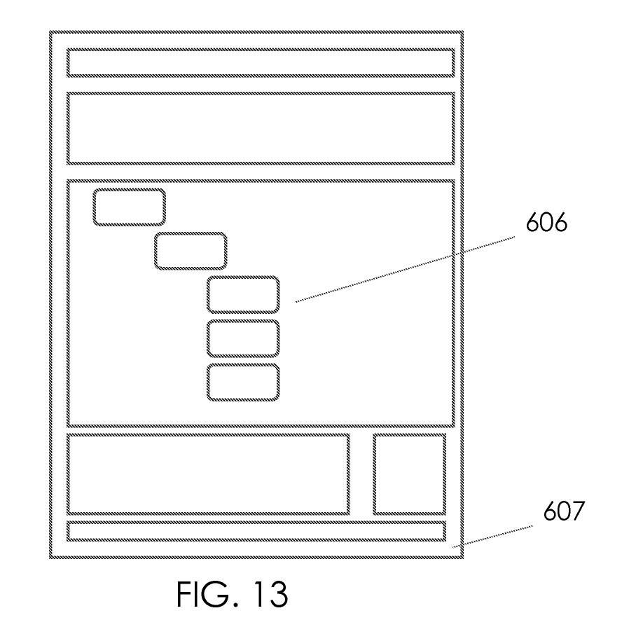

Referring now to FIG. 13, the example of FIG. 12 can be expanded for some or all items. For instance, an item 606 for “FIG. 11” now has a URL address 607 for the location of the illustration.

Another example of using the name and the URL without information in the descriptive block includes the internet links to various search engines of the world. Other examples include links to files where the name indicates the nature of the file; launching applications; and retrieving particular faxes or emails. Generally, the name and URL information is the fastest way of “building” the project file—descriptive material is added as necessary and/or desirable for more intensive use.

The URL may be used to save searches which may be several hundred characters. An additional URL can be inserted into the URL, such as emails which launch other functions. The URL field is designed for maximum flexibility to utilize functions which fall within the category of generally recognized URL Schemes or private schemes which may be identified or created.

In one example, an emergency weather notification system can send email to all designated recipients in the event of bad weather. Similarly, a Board of Directors or other group may be designated so that an email may be sent to the entire group.

### Example

### Accessing Name and Description

In one embodiment, the descriptive pane can include full text of web site, or about 10 pages of text, or about 32,000 characters. The text in the descriptive pane is searchable so that the user may enter a desired text string. In one embodiment, the system will return create and return a new list of links related to the search term.

In this embodiment, the name and descriptive block are used, but the URL is typically not used. One example is a list of pending legislation, where the name is used for subject matter organization, and the description is used for actual portions of the legislation.

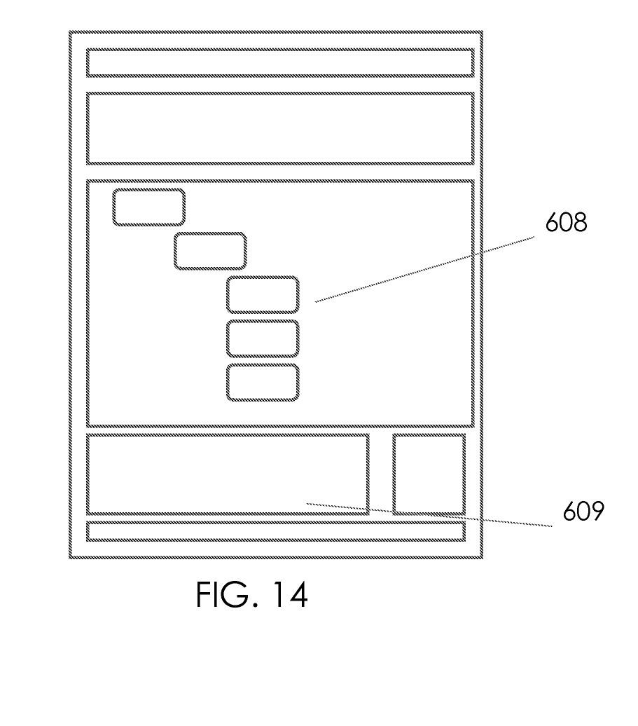

Referring now to FIG. 14 an item 608 for “FIG. 9” now has a status notation in the Description field 609.

Another example is a second step in project development. After a name only outline is developed, the user may begin to incorporate descriptive material associated with some of the names.

Other examples include checklists, maintenance of time records, and phone logs. In general, any information that a user might save from somewhere else can be organized in a way that it can be accessed faster.

In one embodiment, the descriptive block preserves the rough format of spreadsheets. For example, the descriptive field may hold about 2000 database records from a 4 column database, and the records are presented in a manner that is similar to the spreadsheet layout.

### Example

### Accessing Name, Description and URL

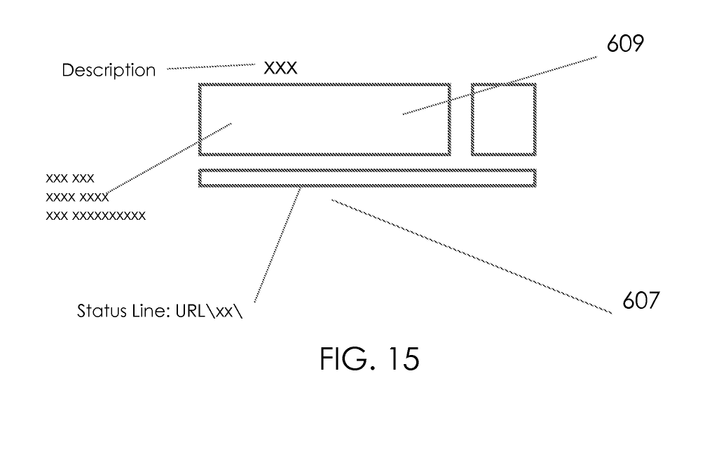

In this mode, the user may inspect the name and the description block before electing to access a URL link. This utility supports searching and previewing as well as the organization and display of useful content. For example, the information of FIG. 14 can be enhanced by including a URL for more complete or supplemental information as illustrated in FIG. 15 where a URL 607 has been added, or to directly access a document.

### Example

### Accessing by Name and Q-Tag

In a ski resort example, a list of resorts may be represented alphabetically in a tree structure and further selected by use of an identifying Q-TAG such as state.

In another example, a user can mark items for later recall by inserting an asterick or any other character or symbol in the Q-tag field.

### Examples of Use

The invention supports a wide range of uses as illustrated by the partial listing of examples described below. Some types of uses include indexing the internet or portions of the internet; a previewing tool for examining content without opening a file or accessing a link; an operating tool for tablet computers, notebook computers, and handheld devices; a sponsor advertising tool, an association content tool, an organization of functional content, and a project assistant.

As described more fully below, the invention may be employed in a wide range of subject areas on a variety of devices. The concise library, tab, outline representation of links coupled with the preview capability, makes the system appropriate for devices with limited display areas such as handheld devices, phones, and notebook or tablet computers. This condensed presentation of material is also useful for conventional desktop computers.

Some embodiments of the tool are relatively passive presentations of content, such as provided through associations and specific content such as multi-media books. In many cases, this content may be modified by the user, but the general structure of the content may be relatively stable. This organized presentation of useful content may be in the form of privately labeled software for organizations.

In other embodiments, the tool becomes a Project Assistant for organizing information from a bare template or even a blank library. In these types of applications, the user may be conducting an Internet research project, or simply organizing materials from a local computer.

These applications are examples of information organizers, database organizers, or desktop organizers.

The ability of QLynx to display all of its items in a tree-view is extremely useful in a PC desktop device embodiment, as well as embodiments for tablet computers and handheld devices such as pocket PC's and cell phones.

### Small Display Devices

The concise representation of Qlynx makes the tool particularly useful for cell phones, Personal Digital Assistants, and other small display devices. The representation format can be similar for both small display devices and large screen monitors. One advantage to using the tool for small display devices is that large amounts of information can be organized and retrieved with minimum keystrokes.

One aspect of the invention is its function as an extensible directory. A directory may be created and subsequently be annotated, modified, and searched. Annotations include names and description fields. Modifications include adding subdirectories and copying or moving items to another directory. Searching may include the creation of new search results which may be further annotated, modified, or searched.

### Example

### Indexing

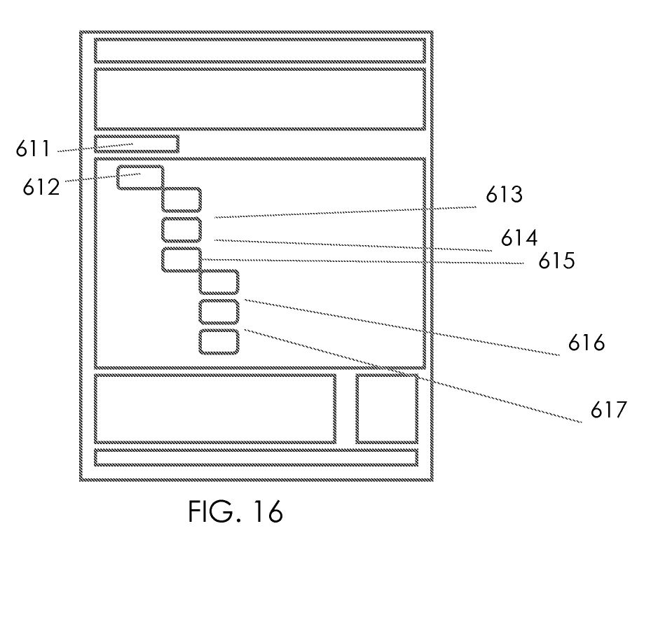

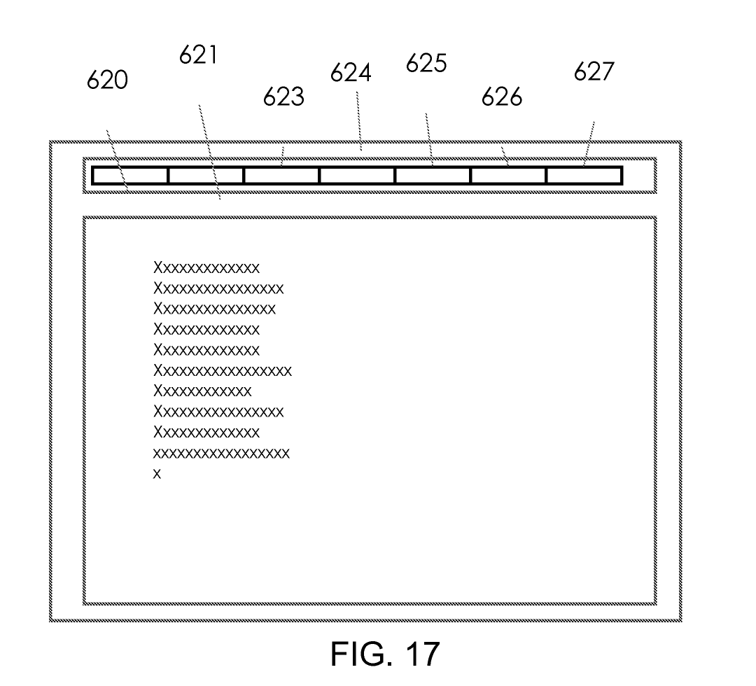

FIG. 16 shows an example project for media. The first level tab 611 has a descriptive name “QlynxTexasMedia”. A “Cities” folder 612 includes folders for a number of cities which are presented alphabetically in this example, including Abilene 613, Amarillo 614, and Austin 615. The Austin folder 615 has been expanded to show links including Austin City Search 616 and KEYE Live 617. Links may be further grouped by newspaper and media, television and cable news, government sites, foreign sites, etc. The user may click on a folder such as newspapers and media and access though the QLynx paw icon to AP wire services and other sources such as the New York Times, News Week, Time Magazine, USA Today, etc. This representation permits rapid access to the actual content portions of a variety of media sources. An additional usage of this function is in a live-update and refresh capability which provides an immediate and up-to-the-minute capability to receive urgent information such as storm alerts, news feeds, QPF updates, warnings and critical information.

In one embodiment, the invention permits faster access to filtered links. Because the capacity in size of QLynx Project Files permits the luxury of identifying the means of indexing the Internet's 17 million pages (by creation of multiple tabbed projects), a search inside a category is instantaneous and there is no search delay—select the search, click on the link, and delivery is with the speed of the user's dial up, cable, DSL service, or other Internet connection.

### Example

### Multiple Tabs

Referring now to FIG. 17, which demonstrates the nesting of tabs 620-627 in an example application. Other numbers of tabs can be used, and a 16 tab limitation is typically appropriate based upon practical limits to a conventional computer display device.

The invention supports more efficient links to existing user or customer content. One aspect of QLynx is the ability to efficiently direct a user to specific locations including programs, files, and websites. Prior art navigation is often limited to the Windows Explorer environment, marking of favorites, and cumbersome navigation of web pages through connected links. In many cases, the user has to backwardly navigate through links to go around them.

QLynx—with its folder structure and multiple sessions or tabbed projects, permits a “flatter” identification of known links—to directly progress to the location rather than navigating to reach it.

### Example

### Previewing and Searching

In one embodiment, QLynx provides both a descriptive name field that provides some information about the nature or content of a link, and a descriptive field which can include a substantial amount of actual content or a summary of the link. By displaying the name and the description fields before accessing a particular link, QLynx provides a previewing capability so that a user can be more selective on what links are accessed.

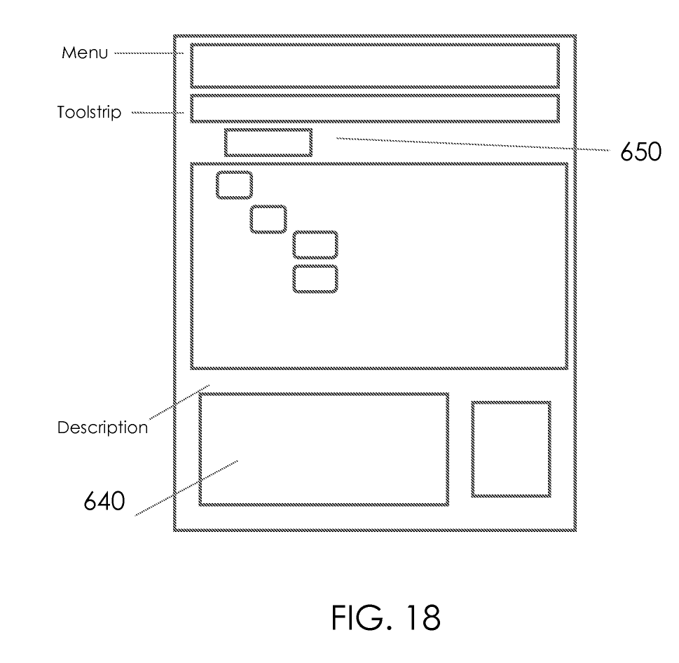

Referring now to FIG. 18, in one example, QLynx may be utilized for a preview of advertising content through its Descriptions Pane 640 of the General Display 650. In this example, a portion or all of the lyrics of a selected song may be displayed, or the display may also include advertising.

In another example, a magazine may permit any or all of its advertisers to be listed and to display the exact content of the advertisements in the particular issue of the magazine. The concept expands further with a virtually unlimited possibility of other textual content in that pane. Graphic content may be displayed directly by addressing its physical location—without accompanying text or download times of entire web pages. For instance, a single picture may be addressed as c:\picture.jpg or http://website.com/picture.jpg. This ability limits delays to the extent of the size of the image displayed, where text displays will be displayed simultaneously with the item in the Project File.

In other examples, one or more graphics may be displayed along with descriptive material.

QLynx can display the contents of any file whose native application permits the “selection” of text within it. That is, PDF files, spreadsheets, databases, word processing documents, web pages, software code, foreign language text, email, and the like are all displayable, searchable, and selectable through QLynx.

Any character in the descriptive block is searchable. In one embodiment, 18 levels of embedded folders may be displayed in a manner that still leaves room for text for the name to be displayed.

QLynx has the ability to display and search automatically all characters in languages which are supported in the Windows environment, including “basic” foreign languages such as Spanish, French and Dutch, but also including Arabic and Hebrew. If the user downloads Microsoft Language Packs for certain languages, they too will be displayed. Punctuation marks may also be searched, which is a useful feature for finding all items which have been tagged, for instance, with a # notation or other symbol.

A previous search may be modified by changing the search terms within the URL A search may be saved by adding an item to the Project and saving the Project as a *.qpf file.

The current invention can provide search results that are structured as opposed to a simple results list that is typically provided with Internet search engines. The search results are structured by URL and information. Search results may be returned in an outline tree form corresponding to the original tree structure that was searched. Thus, both the search and the search results are different based upon the starting tree structure of the search.

### Simultaneous Translation.

By default, the present invention contains the capacity to translate URLs from English to any one of 27 other languages by a single click, and by a double click from the translated language back to English. The mechanism contains a total of 54 “language pairs”, a term in general use within the translation community. By the linkages to the QLynx Tree, the system utilizes four sources of machine language translations. In prior art, the accomplishment of a single translation required entry of a URL into a text box, and then the page would translate, repetition would permit additional translations, and the use of cumbersome menus permits selection of language pairs. Utilizing the QLynx system, the results are displayed quickly, and the ‘navigation’ to the translator is accomplished simultaneously in the background operation of the system. The final time delays are utilized in actual translation, which is relative only to the speed of the Internet Provider. The speed gains in economy of the magnitude of use are further multiplied over the multiple items in a particular tree.

### Example

### Saving Searches as QPFs

In one example a search may be saved as a separate as a QPF file. When the file is recalled, it is usable as any other file. For instance, a list of Colorado ski resorts may saved as a QPF file.

### Example

### Mapping Concantenated Terms to Programmed Tabs

In one example, the tabs may represent a subset of 98 separate search services, and the items in the tree can be simulataneously searched across all of the services. Each search may be executed by automatically cocantenating the item name into the appropriate search input format. This capability reduces the need to store previous search results, and allows the user to access current search results at any time. In this example, various containers are used as the text sources associated with the various tabs, such as GURL1 containing a concantenated text associated with a tab 1 Google™ search format; and GURL2 containing a different concantenated text associated with a tab 2 Yahoo™ search format.

### Example

### Data Resource and Data Management

The tool provides strong data management capabilities, and functions somewhat like a database. A database typically has more restrictions on data representation and data manipulation. The current tool enables a user to effectively organize, search, and manage information through the use of a multiple tree structure, the item representation by name-URL-description, and the search and preview capabilities. The combination of these properties—the tree structures, the data representation, and the search/preview capabilities provides a useful tool for data organization and data management.

### Coordinating Database

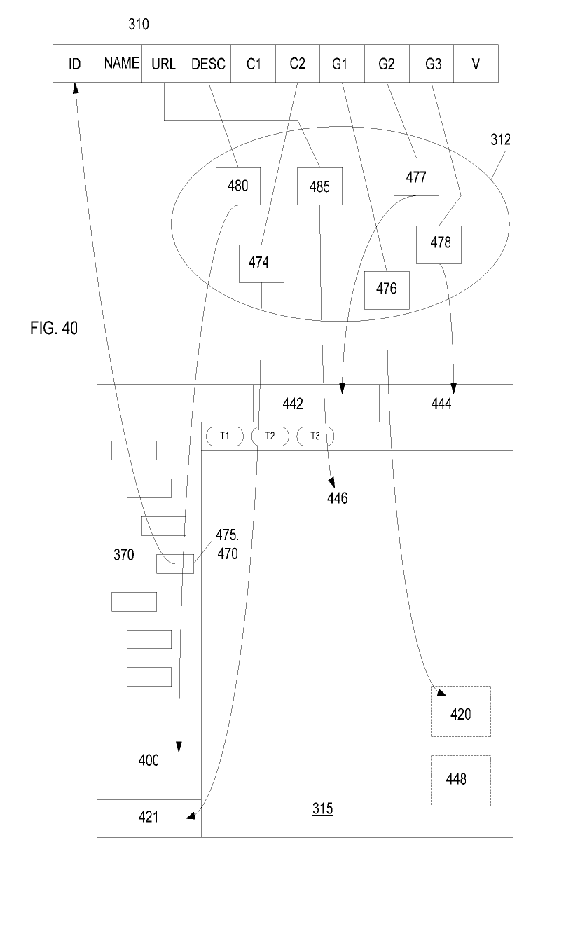

FIG. 40 is a representation of an application tool screen 315, a representative data structure 310, and local or web URLs 312. The tree structure 370 presents a plurality of items which have names 470 and associated item IDs 475. Each of these items has a multiple container data structure 310 which has pointers to corresponding web or local machine URLs as illustrated by element 312.

When an item is selected from the tree, the various display panes are updated according to the current information designated by each of the data containers. In this example, for instance, the main display area 446 presents information designated by the URL container 485; banner advertisements 442 and 444 present graphics or text information from the GURL2 477 and GURL3 478 containers respectively; a graphic display area 420 presents a graphic item designated by GURL1 476, a description pane 400 displays information from the Description 480, and a display area 421 displays a Q-Tag from the CURL2 474 container.

The actual data may come from multiple data bases and multiple sources. The data is not just accessible by the user, current information is brought to the user. The number, size, and arrangement of the various displays is configurable according to the application.

In one example, a missing children database from a hurricane event combines pictures and other information. Data may be obtained from social security, FEMA, Red Cross, search engines and other sources.

In another example, a current terrorist watch list is maintained by drawing information about suspected terrorists from multiple data sources.

The preparation of coordinating databases can be highly automated by developing scripts to populate the data structure containers. The coordinating database may be a stand alone application which permits access to up-to-date information.

### Example

### Use of Qlynx as Front End to Database

In another application, the data sources 312 described above can be from a single database, and Qlynx can serve as a useful front end or user interface to the database.

### Example

### Monitoring v. Browsing Capabilities

In this example, separate browser or search functions are designated by tabs, and one or more search terms is provided to a selected browser when an item is selected. In prior art approaches, accessing separate browser results requires multiple actions. In this example, the results are available faster and more efficiently.

### Example

### Manipulating Lists

In this example lists such as customer content, internet indexing, or search results may be presented in a tabbed outline form and the resulting list may be manipulated.

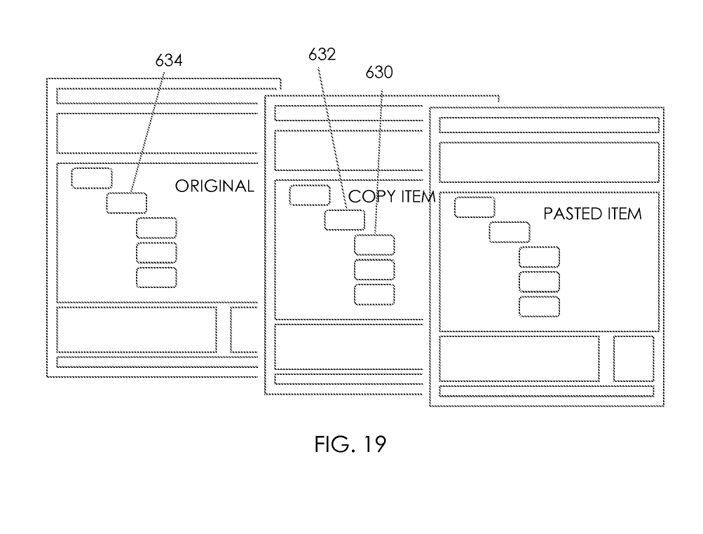

Referring now to FIG. 19, portions of folders and lists 630 may be copied and pasted between a first tab 632 and a second tab 634. The same operation may also be used inside the same tab to rearrange the Project, although the most typical use will be between tabs.

Key documents such as emails and faxes may be organized into folders, copied or moved to other folders, and accessed.

Drag and drop capabilities permit manual rearrangement of items and folders within a single project file.

### Example

### Searching Lists to Create a New File

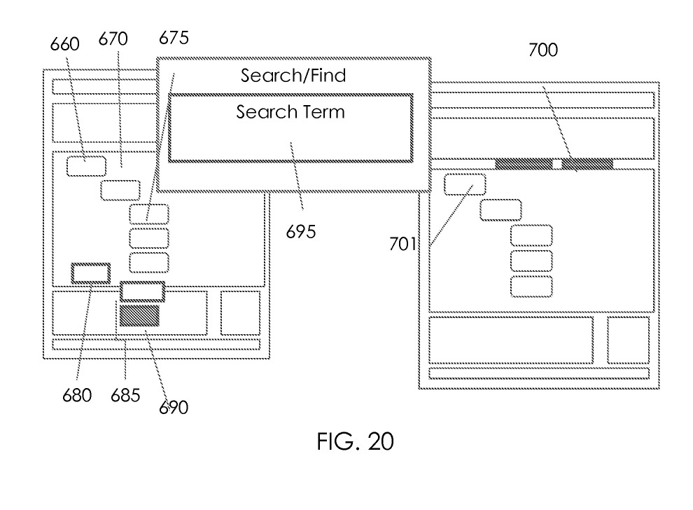

Referring now to FIG. 20, in one embodiment, the search/find feature of QLynx does not just create a results list, but actually creates a separate QLynx Project File 700 which may then be saved and recalled as with other files. This feature permits wider use of searches than just the narrowing of a large list. In a large number of cases, searches will not be necessary because of the careful categorization of items in clearly recognizable items. Unlike some search features in prior art programs, QLynx searches on all characters within an item—Name, URL, and Description.

The search may be conducted at a desired level, and the results of the search may be portable as contrasted by a favorites folder in prior art which typically cannot be moved. The searching acts as the filtering of lists, and is complemented by the ability to create new lists for search results and combining lists.

In this example, a first outline of information is provided. In this first outline, all information is associated with a file, and there is a first high level file 660 which includes all information in the project. The user may select the high level directory 660, or any lower level file or directory such as directories 670, 675, 680, 685, or 690 and conduct a search, such as for a specific term. When the search is conducted, QLynx will create a new tab with a default name “QLynx-search term”. In this example, the search term “Adams” is used in the search field 695 as applied to an intermediate directory 670. The resulting tab will include a new high level tab 701 and could include lower level directories for those entries that contained the search term. Thus QLynx creates smaller lists from a large list. This filtering of the larger lists to smaller lists provides the ability to create a large number of additional project files, which can then be expanded as needed. Each of the smaller lists is fully functional, and may be further manipulated.

### Example

### Combining Lists to Create a New File

In the previous example, a first outline of information is provided in the form of a first portion of a tree 670, such as shown in FIG. 20. The process may be reversed. The user may select all or a part of a second list 701 and add it to an existing list 660, thereby creating a large list from several smaller lists. Examples of this merging to a larger list include individual user creation of a working list from sources such as sponsor-developed content, content which may be purchased from QLynxnet Corporation, or from a website which might collect user-submitted files such as music and graphics collections.

### Example

### Operating Tool

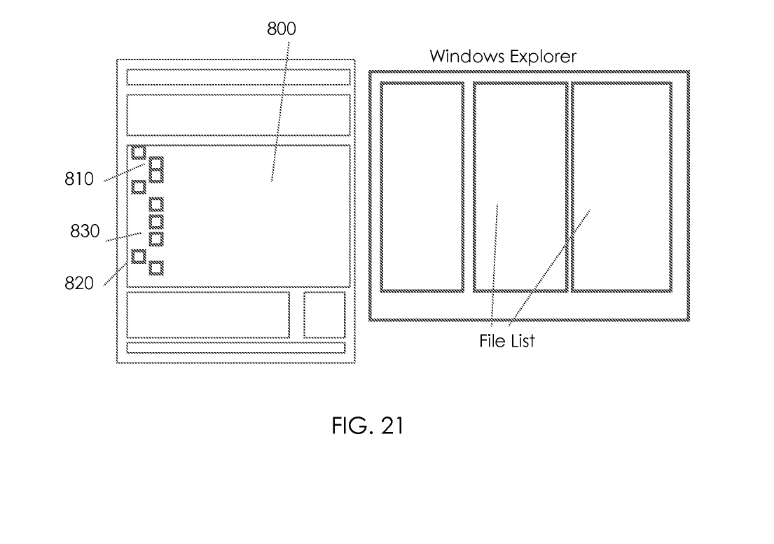

FIG. 21 is an example of a desktop management application. In this application, a single desktop 800 is presented so that a user can launch local application programs from a “programs” directory 820, manage local files from a local directory 810, and may directly access particular projects or clients 830.

The invention supports the efficient launching of programs and opening of files. QLynx can serve as a substitute for the traditional desktop in the Windows™ Environment. This structure is coupled with the ability to use QLynx for notes and other information gathering and display. All files with *.exe file types are launched, and files which have been associated by a file type will open in their native application. More importantly, the contents of the files can be displayed in the QLynx Description Pane without the necessity of either opening the file or launching the program.

FIG. 21 presents a desktop in a traditional manner where application programs may be accessed separately from data. In other applications, such as the project assistant, the application programs may be accessed at the particular step they are required. That access may either be explicit, such as launching a program, or implicit, such as by selecting a link to a local file and thereby automatically launching the application program.

### Example

### Windows™ Manager

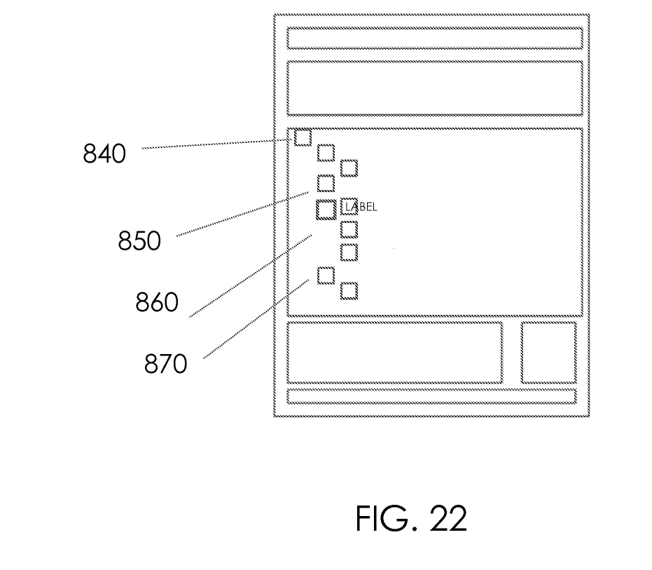

Referring now to FIG. 22, in this example, links are organized for a Windows XP™ operating system grouped by wizards 840, file management folders and directories 850, windows functions 860, tools 870 and control panel. The entries such as expanded under control panel by direct shortcut links to the appropriate programs. This representation and quick access to application programs is useful for both desktop computers and devices with smaller monitors such as notebook computers, tablet computers, and handheld devices.

In one embodiment, the invention supports multiple open windows, each having multiple tabs. Because QLynx is limited only by the user's resident memory, QLynx has only practical limits to Session Windows (individual launches of QLynx). In one embodiment, there is an arbitrarily defined 15-tab limit for each session. In practical terms, QLynx has displayed 2.5 million Internet Links with a 1.0 GB memory (970,000 with 256 MB); over 15,000 full texts of web pages, and the like. With smaller project files, the number of possibilities widens with no loss in speed. More than 150 full project files have been displayed at one time where 10 sessions each having 15 tabs is used.

In one embodiment, QLynx does not eliminate the need for a browser, it actually circumvents some of the messiness of the browser for its direct access to websites. That is, in prior art, the browser is typically launched with a default home page, and there will be at least some delay for the clutter caused by the default. QLynx eliminates the need for opening the browser—it merely launches a web page (*.htm) in its native application, which is the browser.

### URL Types

A partial list of Uniform resource locator (URL) types includes
file://
http://
mailto:
telnet: for research libraries
wais: wide are information services
news: news groups
ftp: file transfer protocol

For example, in the current invention the mailto: URL opens the default Internet mail program and sends a message to the designated mail client. Specific telnet addresses may be provided to access libraries or specific content at a telnet site. The fax utility may be accessed directly in the send fax mode, cover page designer, or receive fax mode. The file transfer directly accesses the web site for transferring a file, and is faster than accessing an ftp program. These capabilities permit QLynx to operate faster than prior art tools. Another example of the time saving capabilities is shown in the ability to directly open a “new blank document” instead of the more consuming constraints of the program.

### Dynamic Advertising

In this embodiment, one or more advertising displays are provided on a QLynx Project Assistant screen in a manner that permits dynamic updating of the display. This capability permits counting, timing, and otherwise determining the exposure of individual advertising screens. The determination of exposure permits control of the advertising images, and the determination of advertising charges to be billed to the advertising sponsors. The dynamic nature of the display also permits the selection of specific images to be displayed as particular items of interest are reviewed with the QLynx Project Assistant.

For example, referring to FIG. 39 which is one configuration of an application display, each of the display areas 440, 442, 444, 420, and 448 can provide different advertising information. Thus when a user selects an item, information about the item may be displayed in the main display area 446, the description area 400, and a Q-Tag area 421. The other area are available for either additional information, for advertising, or for both content and advertising.

These features permit QLynx to serve as an effective Functional Advertising Device with capacity to display advertising or informational material of an entity either while the program launches, or is in a wait state to launch programs, files and Internet Links.

In one example, the advertising comprises time-delayed splash screens or brief displays of a message upon launch of the Program or upon designated launches of specific QLynx Project Files. In another example, estimates of the number of future advertising or logo impressions may be made assuming estimate user exposure per day, or for continuous display of a primary logo.

The ability to make changes which appear, to the user, to be within the program greatly enhances the capability of QLynx as a functional advertising device, since the available technology permits the precise counting of the number of times an image is displayed—or impressions which are made. Such statistics permit the sponsoring entity or service provider to contract for and deliver changeable, countable, and refreshable advertising on a fee-basis which is precise, and capable of driving compensation rates.

### Example

### Sponsor Advertising

In one embodiment of the invention, a sponsoring organization such as a soft drink company makes available one or more types of project files for its potential customers. As the customers use the project files, the sponsoring organization's logo is present on the display screen. The sponsoring organization then has an advertising benefit to providing the tool and particular content to its target audience.

In addition to the option of always displaying one organization's logo, the tool may also be used by the organization to permit other organizations to display their logo. For instance, a sub-sponsor may desire that users see a separate logo such as Magazine Sponsor/Advertiser Sub-sponsor. If a file project name is the same as a graphic file, the splash screen will launch filename.qpf and filename.jpg.

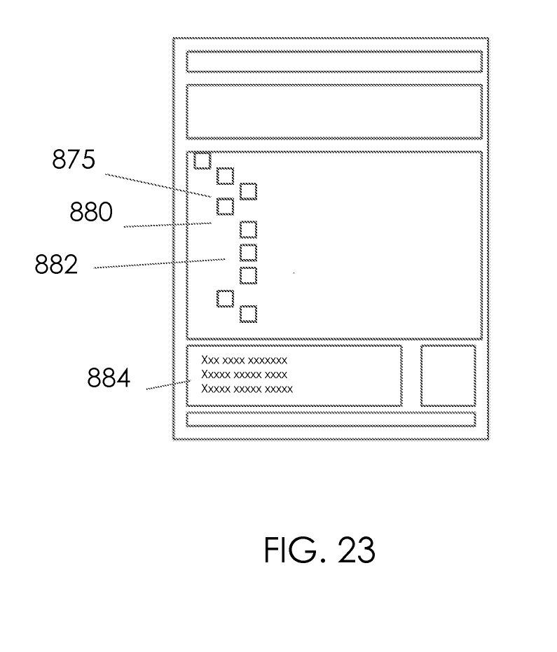

FIG. 23 is a publication example. A periodical publication such as Texas Monthly may provide content links 875 and advertising links 880. In this example, there is a link to each advertiser that has a web-page, or for the non-web-pages such as Nordstrom 882, there is a descriptive text in the descriptive block 884 including typically a phone number and an address.

These vendor links provide an e-commerce revenue source and represent a novel advertising medium. The listing of advertisers within the project files, and the ability to have separate project files permit the identification of very specific revenue gaining opportunities. In addition, the design features of the URL field permit “REDIRECTION” so that, if desired, a destination web link can identify the source of the links origin.

### Themed Sponsorship

In a themed sponsorship embodiment, a sponsor may have a limited version of the tool to provide for a specific purpose. In one example, a bank may host its own services to its customers. In this case, the device serves as a secure online banking system which is prevents phishing and identity thefts because no information is requested from the user. QLynx does not seek any identifying information from users such as cookies. All traffic is downstream from server to user, and there is not any dangerous or threatening returns. The system is seen as particularly significant for mobile applications.

In one example of this embodiment, most or all daily functions desired by a user are quickly and efficiently accessible from the application, so that the user desires the application to serve as a default desktop. In addition to the tree structure and display areas previously discussed, it may be useful to have a set of icons for directly launching functions such as email or word processing.

A related example to secure online banking is a child-safe browser which provides access only to approved sites.

### Example

### Teenager Application

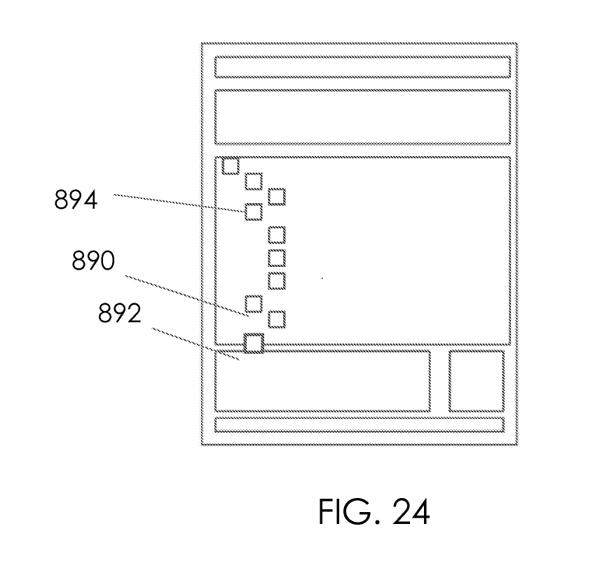

FIG. 24 shows another example which is directed at the teenager market. The files include music 890, pictures 892, and messenger items 894 such as AOL Instant Messenger™. The template permits a user to maintain and efficiently access that content which is of interest to the user. A sponsor such as a beverage company can display advertising on a tool that could be open most of the time during which users are on their computer.

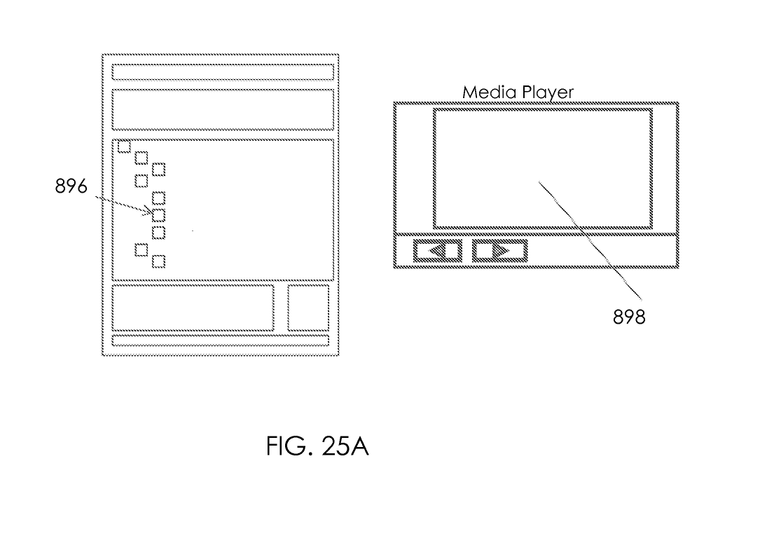

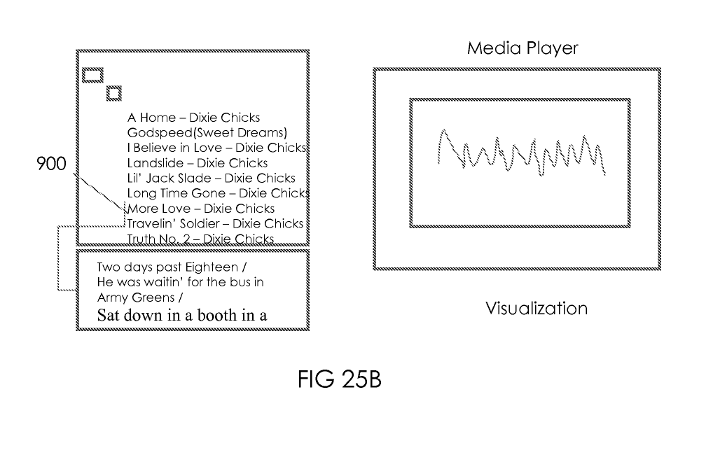

FIG. 25A is an example illustrating how QLynx may launch a video commercial. When the classic hilltop commercial 896 is selected, a video screen 898 is provided to play the video clip. In this example, a sponsor may provide a QPF file, and the user may edit that file as desired. In other examples, the content may be provided without the ability to edit or alter it.

FIG. 25B shows an example of an audio file 900 which may be launched from QLynx utilizing Windows Media Player™. QLynx may be used to catalog, search and launch the contents of audio files such as Compact Discs. Many of the prior art devices do not permit searching, nor do they permit the same type of annotations as made possible by the description pane in QLynx.

### Example

### Organization and Access of Music Files

In the previous example, a music library may be arranged with additional open Project Files depicting a range of entertainment value links and a filtered search on music lyric content. The description panes permit a large capacity of notes on such items, which may be searched as song name, Artist name, year, and the like.

For example, the detailed description may include the song lyrics, so that a search may be done on a few words from the song.

Other projects contain item listings to a variety of links to live television, live radio, live ski-cameras, and audio commercials.

FIG. 25B represents a lyric search for a song including “a bow”. The search provides the link, and the song, which includes a line about “a girl with a bow in her hair” can be launched. As also shown above, the search/find feature locates “bow” and creates a QPF named “MYPLAYLIST-bow.” The name “MYPLAYLIST” is, by default, the name of the Project, “bow” is the search term.

### Example

### Foreign Language News

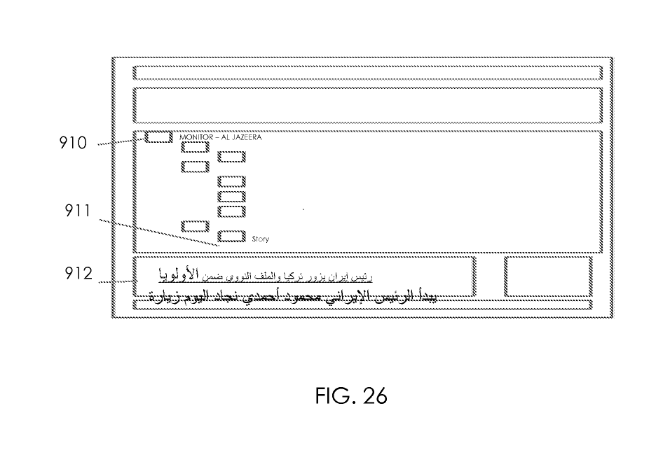

Referring now to FIG. 26 which is a sample page captured from the website of a foreign language cable news organization 910, the QLynx Project would include QLynx icons for web pages of interest as they are contained on the cable news organization website. In this example, the individual Web Pages are launched from the same common interface of a single Project File. The Description Pane 912 contains full text of a story 911 in the original foreign language, from where it can be quickly browsed for content of intelligence agency interest, without the necessity of actually accessing the site.

### Example

### Association Content

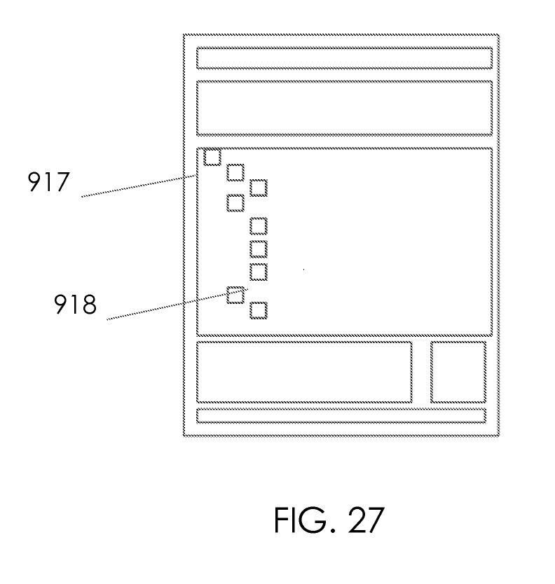

FIG. 27 is an example of an organizational application such as American Association for Retired Persons, AARP. In this case the project opens a direct link to particular web pages such as membership benefits 917 such as discounts 918. This is an example of the application opening both local and internet based programs. Service Provider links are directly accessed by the QLynx to providers such as auto insurance, investment, life insurance, etc. The example may also provide a direct link to email and applications such as word processing programs.

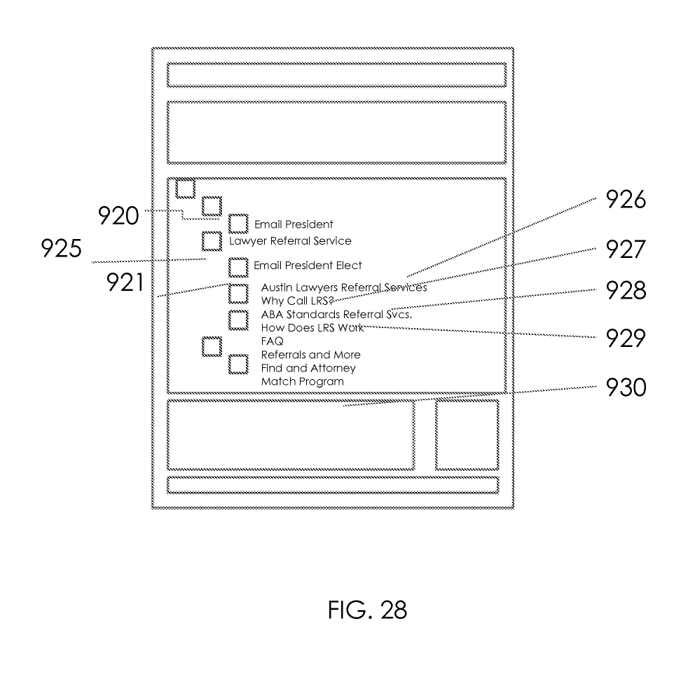

Referring now to FIG. 28, a local bar association maintains a QLynx application with information about the association including email addresses 920 and 921, and references to services 925 provided by the association. In this example, more detailed information about the services 926-930 can be seen when the service directory 925 is expanded. The user may then go directly to the page of interest rather than navigating through multiple web pages. This example also includes a variety of links to other pages of interest to association members.

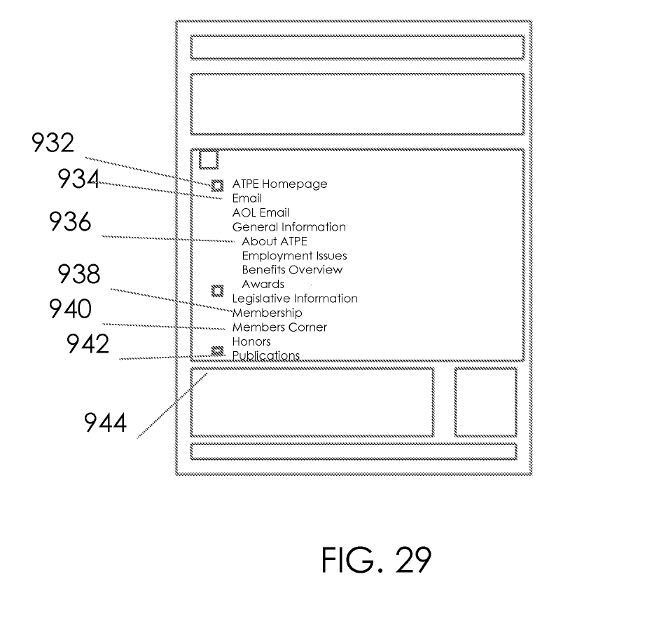

Referring now to FIG. 29, another association example is a Teachers Association including access to homepage 932, email 934, general information 936, legislative information 938, membership 940, news 942, publications 944, and various state and regional content.

### Example

### Functional Content

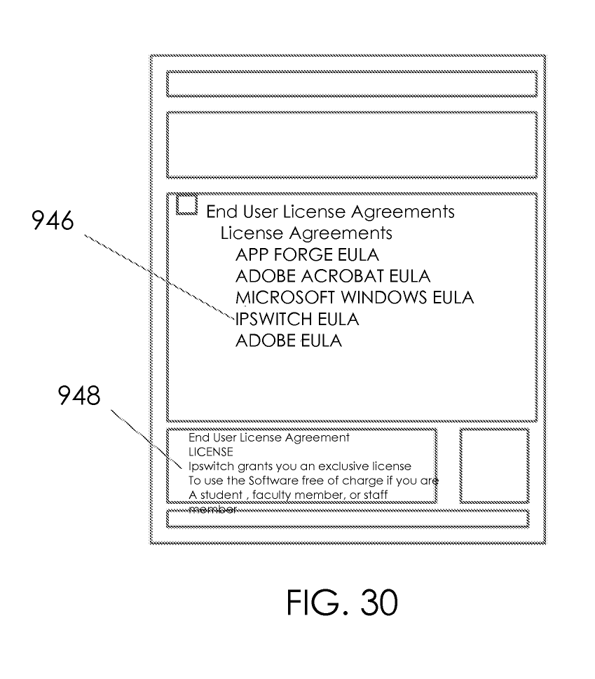

FIG. 30 shows an organization of several types of end user license agreements 946 including direct website access and descriptive materials 948 in the descriptive block of the QLynx main screen.

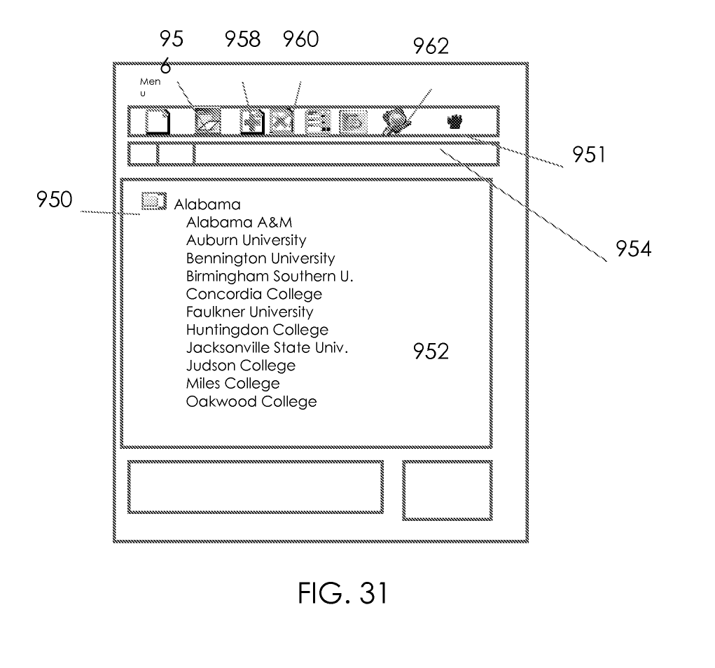

Referring now to FIG. 31 which is a partial listing of a large collection of the home pages of colleges and universities 950. The information contained in each item varies from email address to contact information and is the type which could be beneficially used by high school counselors, or consumers of various types. The project is an example of content development which may be collected for client sponsors who may desire to target that particular market audience. The graphics toolbar 954 provides icons for opening a file 956, filing a collection of links as a “.qpf” file; adding a link 958, deleting a link 960, and search 962. In this example, a QLynx icon 951 is presented near the upper right corner of the display 952. As described above, an organizational icon can be substituted for the QLynx icon. The organizational icon facilitates sponsorship of a QLynx collection by an entity. Other sponsoring icons may be presented. In this example the content includes college web sites, HTML or .PDF college application forms, word processing essays, one or more summary spreadsheet table, and other information. These different file types are organized and accessed under a common outline format so that the same selection process is used for a word processing file as for an internet web site link. In this example, college web sites may be arranged with specific access to admissions or other items.

FIG. 32 is an example of a QLynx file structure for a patent search involving mesquite brush control. The project file includes folders for general information 902, mechanical control 903, and chemical control 904. The mechanical control folder includes folders for several patents or patent applications such as U.S. Pat. No. 5,490,340. When the folder 905 for this patent is opened, the abstract for the patent can be viewed in the description pane. Important portions of the patent may be saved as specific URL links as shown by the link to FIG. 906 so that particular pages or figures from a patent can be directly accessed from QLynx. The combination of the description and the links to specific pages permits rapid access and retrieval of key figures or other material in the patent without requiring the user to scroll through multiple pages. The tree structure organization of the links permits patents and other information to be arranged logically in the same structure. As additional material is discovered, it can be added at an appropriate location in the tree structure such as a new item, a new folder, or a new tab. The ability of QLynx to support and display as many as 20 levels of subfolders means that there are no practical limits to the extension of a concept to its smallest components. The ability of QLynx to search and find across levels permits new concepts to be formed. It is possible to employ another descriptor for the QLynx capabilities in that a “taxonomic structure” or taxonomy may be formed for any possible project—QLynx does not create the taxonomy so much as it permits the creation. However, the organization, search, find and launch capacity provides the functional ability to complete the process of organizational thought.

The double green arrows 907 in the icon lines or the refresh command which takes the Q-Lynx file back to the last saved version. The find feature as indicated with binoculars 908 in the icon line searches the entire name, URL and description fields for a particular clause.

### Example

### Real Estate

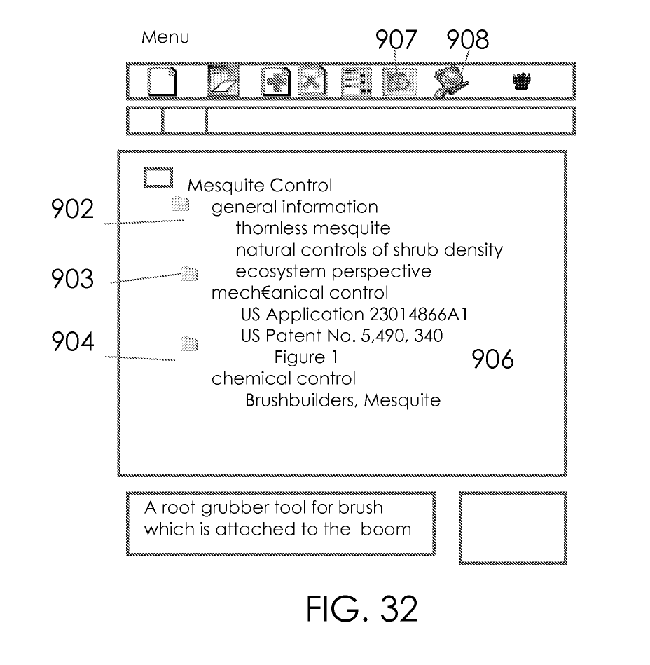

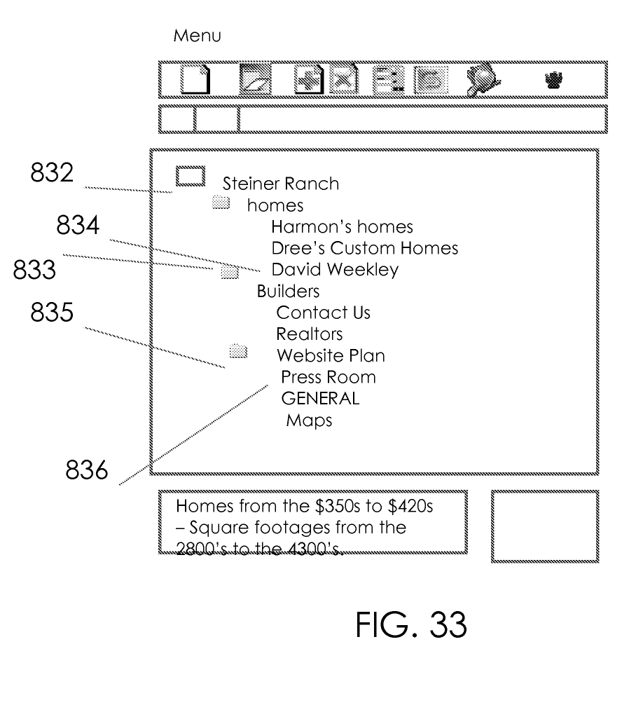

FIG. 33 shows a real estate example for a subdivision 832. Folders are provided for builders 833. When a particular builder 834 is selected, the description block provides information about the builder. A general information folder 835 includes a link to maps 836 and other resources.

### Example

### Project Assistant

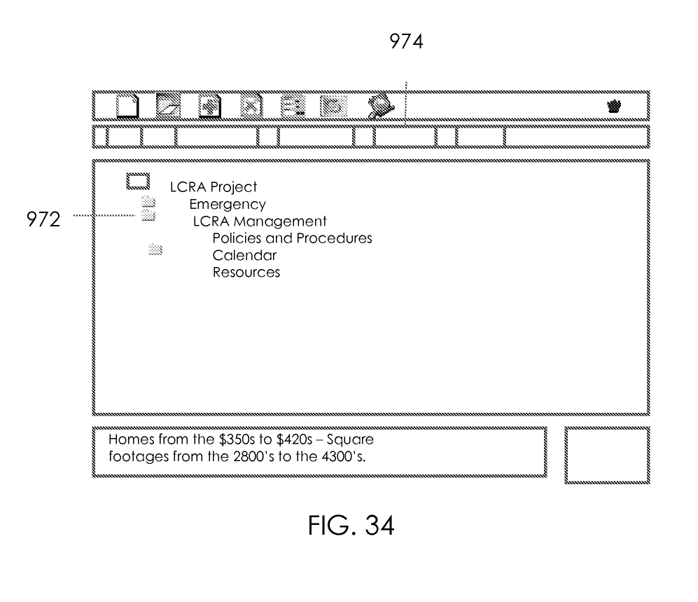

Referring now to FIG. 34, a full screen depiction is illustrated of the various kinds of additional tabbed resource panel which would be of interest for a governmental agency which could utilize QLynx for a Project Management Software tool.

In this embodiment, the multiple links across project files include the ability to launch programs 972, preview and retrieve files 974, and utilize the main qpf file as a task organizer for management of a particular development project. The invention supports customer specific content. Because of its flexibility, and the organizational trees structure of folders and items, QLynx is able to address virtually any project such as coordination of all programs, files, and internet links.

One application of the invention is to use the structure of the sessions, tabs, and outlines of names, links, and descriptions to develop a project. For instance, the user may start with an outline of tabs and names within a session and use that outline to provide a rough scope of a project. As additional information is researched or developed, it can be summarized in the descriptive blocks and accessed through URL links to local or internet files. This project assistant capability is useful for organizing large amounts of information such as an internet research project, and incorporating the user's outline, initial drafts, etc, in a structured manner.

Another example of a project assistant is preparing a term paper. In this example, an outline may be developed and then extended. As the term paper research is conducted, links may be provided to web sites, scanned image files, or word processor or file notes. These direct links are maintained in an outline structure that supports an efficient writing and editing of the paper.

### Example

### Teacher's Log File

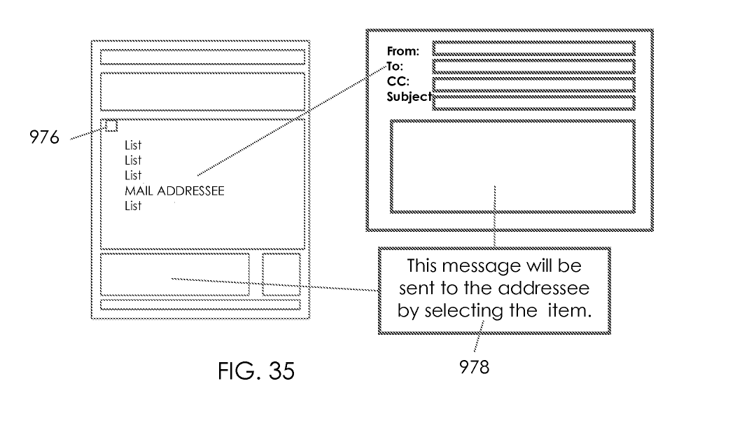

Referring now to FIG. 35, a Teacher's Organization can sponsor, as a member benefit, a LogFile project with which teachers can record notes 976 on progress, grades, disciplinary issues or other classroom events. Such a log file would be of use to receptionists, attorneys, psychologists, emergency operators, or other functions in which it is necessary and desirable to maintain chronological records of events. FIG. 35 also shows an example of an automatic email 978 which can be launched, completely filled in, by the teacher to a child's parents. In the example, the teacher was recording unfolding events in her classroom, when disruptive behavior occurred. Because it is helpful to have an automatic message to the parents, an item was created permitting the message to be sent, while the teacher continues on with the events or with other classroom occurrences.

### Example

### Foreign Language Content

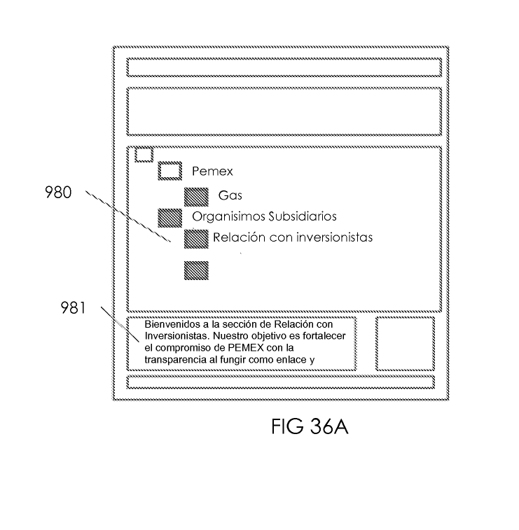

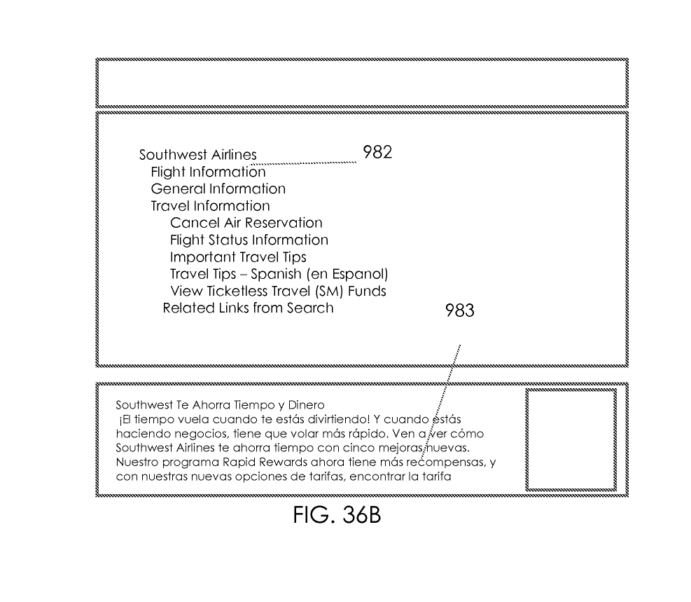

FIG. 36A illustrates the use of QLynx as a website sampler for the national petroleum company of Mexico 980 with Spanish language description 981. FIG. 36B illustrates the incorporation of foreign language content for an airline 982 showing information including travel tips 983. Each of the samples can be utilized as customer information advertisements for the sponsoring organization and are examples of the way in which QLynx can display and utilize the character sets required for foreign language uses.

### Example

### Guide Content for City

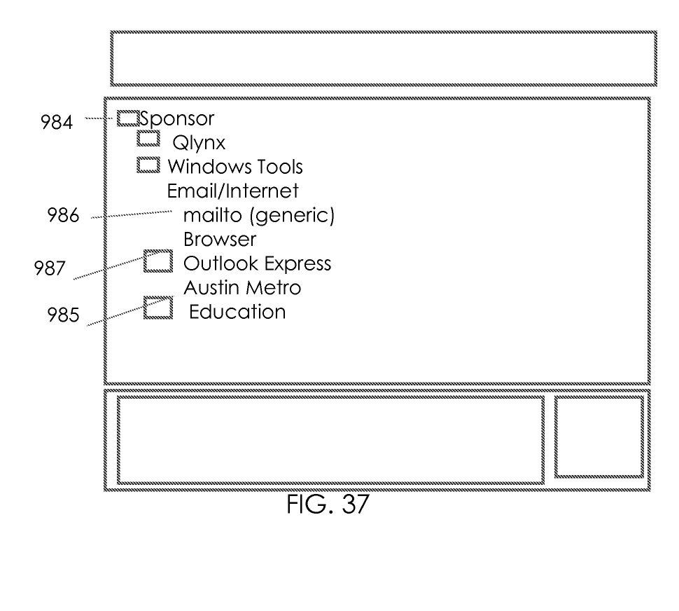

Referring now to FIG. 37, a generic guide for a particular area such as Austin Tex. can be organized by can be organized by showing a sponsor folder 984, area information 985, computer tools such as email 986 and internet access 987, information about a particular area broken down by the area education course, media, etc, specific access to particular television stations in the area.

Generic models have been created which can be expanded city by city, and would be of particular use to a broadly-based consumer sponsor such as one of the interstate banks or media companies such as the cable television providers or within the telecommunications industry.

### Example

### Email Used to Warn Field Crews of Impending Weather Crisis

Utilizing the standard MAILTO function, QLynx has a basic ability to execute all outgoing emails by avoiding a series of delaying screens. That is, utilizing QLynx as one's address book offers a greater ability to speed email and to utilize its capabilities for descriptive notes and other matter.

QLynx can also dispatch email which may be complete as to Addressee, Copies, Subject and Body or for a combination of the items. QLynx also rapidly dispatches group emails to multiple recipients.

The example illustrates an emergency weather alert from the governmental management project shown in FIG. 34. The email provides an instant link to the nearest local weather radar.

### Example

### Nested Folders

In this example, folders can be categorized to a level of at least 18 subfolders within a main topic. The ability to use a large number of subfolders permits efficient organization of information and links.

### Storm Responder

In this embodiment, a QPF template is provided for counties along a coast, called first tier counties, and adjacent inland second tier counties. In one example, the template provides a single point access to 23,000 items related to emergency information, health care, law enforcement, government, education, utilities, along with traffic and weather conditions. Counties may be grouped by state and region such as Gulf, South Atlantic, and Florida regions.

One objective of the tool is to provide all information that a responder or other person or entity would need in a situation where they do not have the time to search for the information. All information is as current for each information source. The tool can provide multiple language translation. The tool may include live channel features for warning and other information within one to two minutes of issuance by NOAA. The small delay permits what is essentially a real-time delivery. Automated emails may be generated by the tool by selecting the contents of a specific container and embedding the contents within a URL string utilized by email programs to send the message. This function is accomplished by a concatenation of the base address with a database field.

In another example, the application may be delivered on media such as a portable drive device so that no Internet connection is necessary.

What is claimed is:

1. A method of presenting a plurality of URL links to a user of a display device, the method comprising
opening a session, the session having a plurality of project tabs;
displaying on the display device, at least a portion of the plurality of project tabs associated with the session, such that the user may select a tab;
determining which tab is selected by the user;
for the selected tab, displaying a tree structure comprising
at least one folder such that the user may select and expand a folder, the folder comprising a plurality of items, each item comprising a plurality of containers including
an item name, such that at least a portion of each item name is presented on the display, such that the user may select a name;
a first URL link associated with the item,
optional descriptive material associated with the item,
a second URL link associated with the item, and
a link to a graphic associated with the item;
determining which name is selected by the user;
for the selected name, presenting
the name,
a URL link associated with the name, and
at least one of
optional descriptive material associated with the item,
results of a second URL link associated with the item, and
results of a link to a graphic associated with the item.
such that the user may review the display and decide whether to access the URL link.

2. The method of claim 1 further comprising
presenting a plurality of folders within the tree structure, such that the user may expand and contract the display of the folders.

3. The method of claim 1 further comprising
associating an advertising graphic with an item; and
displaying the advertising graphic in proximity to the tree structure.

4. An information management system comprising
a computer display device;
a local memory means for storing a first local file, such that the first local file can be accessed by a first URL; and
a tree structure display on the computer display device, such that the tree structure display comprises
at least one folder, and
a first name associated with the first URL, such that an item is associated with the first name, the item comprising a plurality of containers including
the first name,
the first URL link,
optional descriptive material associated with the item,
a second URL link associated with the item, and
a link to a graphic associated with the item,
such that when user of the computer display device views the first name, the first name, the first URL, the optional descriptive material, information associated with the second URL link, and the graphic.

5. The information management system of claim 4 wherein the display device is a handheld computing device.

6. The information management system of claim 4 wherein the display device is a cell phone.

7. The information management system of claim 4 wherein the display device is a tablet computer.

8. The information management system of claim 4 wherein the display device is a notebook computer.

9. A functional advertising device comprising
a computer display device;
a local memory means for storing a first local file, such that the first local file can be accessed by a first URL;
a tree structure display on the computer display device, such that the tree structure display comprises
at least one folder, and
a first name associated with the first URL, such that an item is associated with the first name, the item comprising a plurality of containers including
the first name,
the first URL link,
optional descriptive material associated with the item,
a second URL link associated with the item, and
a link to an advertising graphic associated with the item, such that when user of the computer display device views the first name, the first name, the first URL, and a description of the first URL are displayed on the display device, and such that when the user selects the first name, the first local file is accessed; and
the advertising logo is displayed on the computer display device.
